(19) United States
(12) Patent Application Publication
(10) Pub. No.: US 2025/0209471 A1
(43) Pub. Date: Jun. 26, 2025

(54) METHOD AND SYSTEM FOR WOOD HARVEST AND STORAGE, CARBON SEQUESTRATION AND CARBON MANAGEMENT

(71) Applicant: Ning ZENG, Silver Spring, MD (US)

(72) Inventor: Ning ZENG, Silver Spring, MD (US)

(21) Appl. No.: 19/001,547

(22) Filed: Dec. 25, 2024

Related U.S. Application Data
(63) Continuation of application No. 17/663,433, filed on May 15, 2022, now Pat. No. 12,198,146.
(60) Provisional application No. 63/189,184, filed on May 16, 2021.

(51) Int. Cl. G06Q 30/018; G06Q 10/04; G06Q 10/0631

(52) U.S. Cl. CPC G06Q 30/018; G06Q 10/04; G06Q 10/06313

(57) ABSTRACT

A method for carbon sequestration and management through a wood storage project includes: determining sources of wood used for storage for carbon sequestration with an optimization technique performed by one or more processing circuits, calculating an optimized ratio between carbon sequestration efficiency and cost with the one or more processing circuits, preparing storage facilities (Wood Vaults) with the optimized ratio between carbon sequestration efficiency and cost, selecting suitable material for storage based on size and wholeness of wood with minimum exposed surface area, sorting raw woody material from the sources of wood into fine woody biomass (FWB) and coarse woody biomass (CWB) and storing both the FWB and CWB in the storage facilities, establishing a monitoring, reporting, and verification (MRV) system to ensure the durable storage of wood and monitor any potential impact on the environment.

### CROSS-REFERENCE TO RELATED APPLICATIONS

This is a continuation of U.S. patent application Ser. No. 17/663,433 filed on May 15, 2022, which claims priority to U.S. Provisional Patent Application No. 63/189,184 filed on May 16, 2021. The disclosures of the above-referenced applications are hereby incorporated by reference in their entirety.

### BACKGROUND

Atmospheric CO₂ concentration has increased from a pre-industrial value of 280 ppm to over 410 ppm today, mostly due to carbon emissions from fossil-fuel burning and deforestation. The Paris Climate Agreement envisions limiting global warming to significantly below 2° C. warming, which would require transformation in energy and economic structure, as well as novel technologies to keep atmospheric CO₂ concentration at a safe level.

### SUMMARY

The present disclosure generally relates to methods for wood harvesting and storage, carbon dioxide removal, carbon sequestration and management, and further relates to determining sources of wood used for storage for carbon sequestration with an optimization technique performed by one or more processing circuits, calculating an optimized ratio between carbon sequestration efficiency and cost with the one or more processing circuits, preparing storage facilities (Wood Vaults) with the optimized ratio between carbon sequestration efficiency and cost, selecting suitable material for storage based on size and wholeness of wood with minimum exposed surface area, sorting raw woody material from the sources of wood into fine woody biomass (FWB) and coarse woody biomass (CWB) and storing both the FWB and CWB in the storage facilities, establishing a monitoring, reporting, and verification (MRV) system to ensure the durable storage of wood and monitor any potential impact on the environment.

In an aspect, a method for carbon sequestration and management through a wood storage project is provided, including: determining sources of wood used for storage for carbon sequestration with an optimization technique performed by one or more processing circuits, calculating an optimized ratio between carbon sequestration efficiency and cost with the one or more processing circuits, preparing storage facilities (Wood Vaults) with the optimized ratio between carbon sequestration efficiency and cost, selecting suitable material for storage based on size and wholeness of wood with minimum exposed surface area, sorting raw woody material from the sources of wood into fine woody biomass (FWB) and coarse woody biomass (CWB) and storing both the FWB and CWB in the storage facilities, establishing a monitoring, reporting, and verification (MRV) system to ensure the durable storage of wood and monitor any potential impact on the environment.

In some embodiments, the construction of the storage facility is based on the local condition in one of the 3 types: anoxic, dry, and cold. Wherein, anoxic storage facilities are built in low permeability soil with minimum saturated hydraulic conductivity of less than 10-8 m/s for at least a meter, topped with original topsoil to allow fully functioning biological activities in the topsoil; dry storage facilities are built to maintain bone-dry condition with relative air humidity of less than 10%; cold storage facilities are built by directly storing wood piles in clod places such as Antarctica with naturally freezing condition.

In some embodiments, the method further includes: the fine woody biomass (FWB) and the coarse woody biomass (CWB) are separated by a threshold of 5-10 cm in diameter.

In some embodiments, the method further includes: applying pyrolysis tools to make biochar out of the FWB and filling the biochar to spaces between CWB logs to optimize space use efficiency while increasing total carbon use for sequestration.

In some embodiments, the method further includes: mixing logs with mud in construction of structures comprising at least one of dikes or sea walls, and to enhance strengths of the structures while storing carbon. Logs should be completely wrapped inside the mud of at least 1 meter thickness in all outer directions.

In some embodiments, the method further includes: embedding logs in soil or cement in a pattern. Logs should be completely wrapped inside the soil or cement of at least 0.5 meters thickness in all outer directions.

In some embodiments, the method further includes: the pattern comprises a crisscrossing pattern to meet a mechanical requirement of a construction structure.

In some embodiments, the method further includes: directly pumping tree logs vertically into ground as foundations for constructions and raising the foundations of existing construction structures by pushing down the tree logs after building the existing construction structures.

In some embodiments, the method further includes: parameterizing soil or dirt and selecting the soil or the dirt based on the parameterization to optimize the carbon sequestration in the storage facilities.

In some embodiments, the method further includes: selecting coastal areas threatened by sea-level rise, constructing the storage facilities by burying woody biomass underground, refilling soil on top, and regrading surfaces of the selected coastal areas into higher structures than original flat low land, to create varying topography, enhancing biodiversity while controlling sea level rise.

In some embodiments, the method further includes: installing sensors and instruments to monitor the storage facility for physical, chemical, and biological parameters for wood preservation, including but not limited to: concentrations of CO2, O2, CH4, temperature, humidity, pressure, pH, redox potential, dissolved O2.

In some embodiments, the method further includes: installing sensors to measure the fluxes of CO2 and CH4 to ensure there is no methane leakage into the atmosphere.

In some embodiments, the method further includes: simulating, using the one or more processing circuits, gas concentrations, migration of gases and water and air in their horizontal and vertical movement, including transport via advection and diffusion in 3D numerical models.

In some embodiments, the method further includes: the 3D numerical models simulate distribution of biomass and gases including at least one of wood, O₂, CO₂, or CH₄, and bio-chem-physical processes that govern sources and sinks of the biomass and the gases, and diffusion/transport through soil layers.

In some embodiments, the method further includes: simulating pH, and ORP redox potential (ORP).

In some embodiments, the method further includes: calibrating and validating the 3D numerical models with experimental data.

In some embodiments, the method further includes: the 3D numerical models are configured to simulate gases and H₂O dynamics within the storage facilities and also processes along soil profiles to surface where greenhouse gases of CO₂ and CH₄ are emitted.

In some embodiments, the method further includes: the 3D numerical models comprise a model of transport, diffusion, with sources and sinks:

$$\frac{\partial c}{\partial t} = - v \cdot ∇ C - \frac{\partial {F}_{x} ( C )}{\partial x} - \frac{\partial {F}_{y} ( C )}{\partial y} - \frac{\partial {F}_{z} ( C )}{\partial z} + Sources - Sinks .$$

In some embodiments, the method further includes:
performing, with the one or more processing circuits, a carbon accounting including:
   establishing a baseline including an assessment of lifetime of the sources of wood based on time scales including a half-life time, and a 5% decay time;
   assessing a lifetime of buried wood based on storage methods and environmental conditions, wherein the lifetime of the buried wood is classified into stop-gap (<20 years), short-term (20-100 years), semi-permanent (100-1000 years), permanent (>1000 years), and ultra-permanent (>10000 years);
   constructing a single-parameter model:

$$C = {C}_{0} exp ( - \frac{t}{τ} ) ,$$

wherein C is a carbon pool size with an initial value C₀, t is time, and τ is an e-folding decay time scale, or,
constructing a multi-parameter model:

$$\frac{dC}{dt} = J ( t ) - {\int }_{0}^{τ} J ( t - τ ) Γ ( τ ) d τ ,$$

wherein I (t) is a gamma function and J is a continuous input added wood to the carbon pool with parameter values based on the assessed lifetime.

In some embodiments, the method further includes: simulating, using the one or more processing circuits applying the single-parameter model or the multi-parameter model, a continuously evolving carbon gain at a specified time interval; and displaying, with one or more display screens, the simulated continuously evolving carbon gain to users.

Other aspects and implementations may become apparent in view of the following drawings and detailed description.

### BRIEF DESCRIPTION OF THE DRAWINGS

FIG. 1 illustrates wood harvest and storage (WHS) as a method for carbon sequestration. from a global carbon cycle perspective, trees act as a ‘carbon pump’. Part of the assimilated carbon is ‘siphoned off’, by selectively harvesting or collecting wood, then stored permanently or semi-permanently. As forest continues to grow sustainably, the net effect is to remove CO₂ from the atmosphere. the numbers (in gtc/y), illustrating an ambitious scenario that could sequester ⅓ of current fossil fuel emissions. The well-preserved wood can be a future source of biomass raw material, bioenergy, or co2 should future needs change after the current climate crisis is over.

FIG. 2 is a diagram illustrating decomposition rate depends on environmental conditions and characteristics of stored wood: moisture, temperature, oxygen concentration, and surface area. Plots are for typical parameter values than depend on specific conditions such as wood species.

FIG. 3 is a diagram illustarting the importance of moisture and oxygen condition in influencing wood preservation. Both dry and wet conditions can be utilized for wood storage, but the specific circumstances can impact the longevity greatly. Keeping the water stagnant by sealing with clay or synthetic material can significantly extend the lifetime by reducing the chance for oxygen replenishment and maintaining extremely low oxygen level.

FIG. 4 is a diagram illustrating a method for type-A opportunistic wood sourcing.

FIG. 5 is a diagram illustrating a method for type-B wood sourcing from managed forest.

FIG. 6 is a diagram illustrating a type-A project. Wood is sourced from opportunistic sources such as urban waste wood disposal. The carbon gain for carbon credit is ‘avoided’ carbon emissions relative to a baseline.

FIG. 7 is a diagram illustraing a type-B project. Wood is sourced from sustainably managed growing forest. Repeated harves-storage cycles lead to long-term accumulation of carbon gain.

FIG. 8 is a schematic diagram of cost optimization with processes and sub-models.

FIG. 9. is a diagram illustrating a method for wood storage, wherein, fully sealed wood, buried in ‘worst-case’ scenario, inside fluctuating water table. Dark layers indicate sealing.

FIG. 10 is a diagram illustrating another method for wood storge, wherein, buried wood is above water table.

FIG. 11 is a diagram illustrating another method for wood storge, wherein, wood is buriedbelow water table with lateral water flow.

FIG. 12 is a diagram illustrating another method for wood storge, wherein, wood is buried under water table with no or little lateral flow (stagnant).

FIG. 13 is a diagram illustrating another method for wood storge, wherein, wood is stored in-situ and buried underground in trench.

FIG. 14 is a diagram illustrating another method for wood storge, wherein. wood is buried in-situ with mound.

FIG. 15 is a diagram illustrating another method for wood storge, wherein, wood is buried on a slope.

FIG. 16 is a diagram illustrating another method for wood storge, wherein, a large-scale wood burial facility with surface intrusion (hill) is provided. After closing of the top, grass and shallow rooted trees can be allowed to grow, then used as park, grazing land, cropland, solar farm, or a combination thereof.

FIG. 17 is a diagram illustrating another method for wood storge, wherein, a large-scale wood burial facility underground (pit) is provided. After closing of the top, grass and shallow rooted trees can be allowed to grow, then used as park, grazing land, cropland, solar farm, or a combination thereof.

FIG. 18 is a diagram illustrating another method for wood storge, wherein, managed large shelter for above ground storage is provided.

FIG. 19 is a diagram illustrating another method for wood storge, wherein, an in-situ shelter is provided.

FIG. 20 is a diagram illustrating another method for wood storge, wherein a centralized wood storage facility collects from a variety of sources such as natural waste wood from surrounding region.

FIG. 21 is a diagram illustrating another method for wood storge according to an embodiment of the present disclosure, wherein a super-size facility consisting of multiple burying units built horizontally and vertically on top of each other is provided.

FIG. 22 is a diagram illustrating another method for wood storge, wherein, wood is submerged under stagnant water bodies.

FIG. 23 is a diagram illustrating a system for carbon accounting, certification, and carbon credit transaction, wherein, monitoring and verification of both wood sourcing and storage will ensure the net carbon value.

FIG. 24 is a diagram illustrating a network-based system for wood sourcing monitoring for sustainably managed wood sources.

FIG. 25 is a diagram illustrating a network-based system for wood sourcing for opportunistic wood sources.

FIG. 26 is diagram illustrating a network-based wood and carbon storage monitoring, accounting and transaction system.

FIG. 27 is a Process flow diagram (PFD) of a Wood Vault, including both biologically derived carbon, fossil fuel CO₂ emissions and energy flow from machine operation. Process boundary here starts from collection and transport of wood residuals, and ends at durably stored carbon in the vault.

FIG. 28 is a diagram illustrating a wood storage facility monitoring system for the purpose of buildimg 3-D numerical models.

### DETAILED DESCRIPTION

The present disclosure relates to methods for wood harvesting and storage, carbon dioxide removal, carbon sequestration and management, the methods comprise determining sources of wood used for storage for carbon sequestration with an optimization technique performed by one or more processing circuits, calculating an optimized ratio between carbon sequestration efficiency and cost with the one or more processing circuits, preparing storage facilities (Wood Vaults) with the optimized ratio between carbon sequestration efficiency and cost, selecting suitable material for storage based on size and wholeness of wood with minimum exposed surface area, sorting raw woody material from the sources of wood into fine woody biomass (FWB) and coarse woody biomass (CWB) and storing both the FWB and CWB in the storage facilities, establishing a monitoring, reporting, and verification (MRV) system to ensure the durable storage of wood and monitor any potential impact on the environment.

The primary pathway to reduced greenhouse gas emissions is a transition to “low carbon economies,” in which energy efficiency is improved and energy production has a much lower carbon footprint by transforming the energy infrastructure to include more renewable technologies and carbon capture and sequestration. Such a transition, however, is quite difficult to accomplish at the rate required to limit global temperature rise of 2° C.—the switch to low-carbon infrastructure is a slow process due to a variety of technological, socioeconomic, and political barriers. Thus, carbon sequestration, namely capturing carbon that is already in the atmosphere and locking it away, could play an important role in the cost-effective stabilization of atmospheric CO₂ at acceptable levels. Negative emissions will also be needed in light of the long lifetime of atmospheric CO₂ even after emissions are completely stopped. Indeed, nearly all future emissions scenarios that involve policy-intervention assume significant contribution from carbon sequestration.

The removal of CO₂ from the atmosphere can utilize physical, chemical or biological method (National Academies of Sciences Engineering and Medicine (NASEM), Negative Emissions Technologies and Reliable Sequestration: A Research Agenda. The National Academies Press, Washington, D.C., 2019). Biological carbon sequestration, hereafter bio-sequestration, relies on plant photosynthesis to capture CO₂ and assimilate the carbon into biomass. Examples of bio-sequestration include reforestation, no-till agriculture, and intensive forest management. Afforestation or reforestation is arguably the most widely embraced carbon sequestration technique because of its low cost, benign nature and many co-benefits. Unfortunately, its capacity is limited by the availability of land and the sink slows down as the forest matures. Because fossil fuel emissions from energy production continue to increase beyond the sequestration capacity of terrestrial ecosystems, mitigation through land-use management is usually viewed as a low-cost approach with relatively modest total mitigation potential.

The greatest potential for bio-sequestration may not come from one-time carbon storage in live biomass, but from using plants as a ‘carbon scrubber’ or ‘carbon pump’. For example, despite the attractiveness of reforestation, the carbon sink diminishes as a forest matures. An alternative is to manage a forest in a way to separate ‘carbon removal’ via photosynthesis from ‘carbon storage’. We can siphon off a fraction of the large biospheric productivity and store it away semi-permanently, thus creating a continuous stream of carbon sink. If our active management stores, say 3 GtC y⁻¹, or 5% of the terrestrial NPP, we can absorb more than ⅓ of current fossil fuel CO₂ emissions. Such reasoning lies behind recent estimates of large (theoretical) bio-sequestration or bioenergy potential through forestry and agriculture (N. Zeng et al., Carbon sequestration via wood harvest and storage: An assessment of its harvest potential. Climatic Change 118, 245-257, 2013).

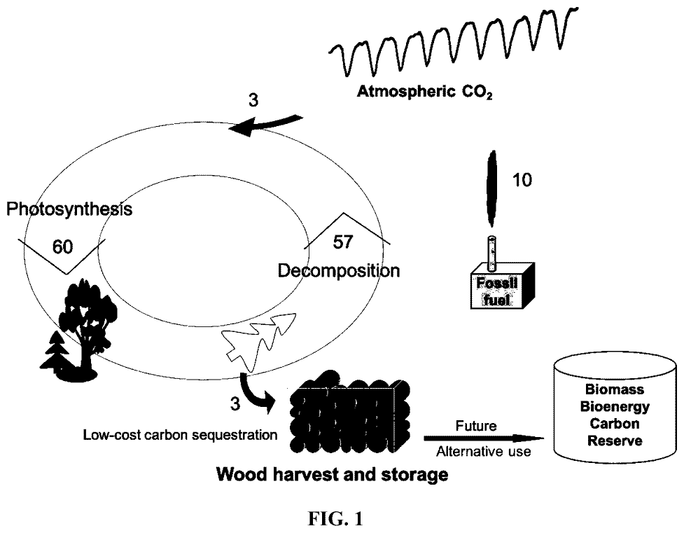

A biological carbon sequestration strategy, hereafter termed Wood Harvesting and Storage (WHS) has been proposed in which forest is actively managed, and a fraction of the wood is selectively harvested via collection of dead wood or selective cutting of less productive trees, and the logs are buried or stored above-ground to prevent decomposition (FIG. 1). Compared to many traditional carbon management ideas in which the stored carbon saturates after a period of time, WHS creates a continuous stream of sequestered carbon. Carbon in stored wood would be relatively easy to monitor and verify, reducing risk of loss and other issues facing some other carbon sequestration strategies.

The estimated potential of WHS ranges from 2-10 GtCO₂ y⁻¹ (1 tC is 3.67 tCO₂). In practice, this will come from a variety of sources such as waste wood and managed timber land. The methods of sourcing wood will determine the quantity of sequestered carbon. The preservation of wood for hundreds of years or longer for climate mitigation exceeds the usual timescales assumed of bio-sequestration such as reforestation or soil conservation. Active management to extend the lifetime of stored wood will be critical for the success. Carbon monitoring, full carbon accounting from source to storage will be essential for carbon credit.

Wood is a wonder material evolution created in vascular plants to support their 3-dimensional structure. The emergence of vascular plants 400 million years ago from ground-creeping photosynthesizers revolutionized the terrestrial biosphere, leaving the legacy of coal as their transformed remains.

Wood consists of mainly three key ingredients: cellulose, hemicellulose and lignin. Cellulose is a quasi-crystalline polymer formed by thousands to tens of thousands of glucose, which form long fibrous bundles connected and strengthened by shorter hemicellulose and amorphous lignin. Cellulose, hemicellulose and lignin are all carbohydrates and composed of C, H, and O in proportions similar to glucose, the simplest sugar (C₆H₁₂O₆)ₙ. While cellulose is long chains of glucose, hemicelluose are much shorter, often linking the long cellulose fibrils in cross-sectional direction of the cell wall. Lignin is a high molecular weight polymer of aromatic compounds, thus its high resistance to decomposition. Lignin is a main component of the soil humus. The typical C:N ratio is wood is 200:1, compared to 20:1 for leaves. Thus, when wood is buried, nutrient loss is relatively small. Importantly, in wholesome wood structure, lignin forms a scaffolding to protect cellulose and hemicellulose.

Wood can be degraded by physical, chemical and biological processes. When buried under ground, the physical disturbance will be nearly non-existent except under special circumstances such as earthquakes and landslides. Chemical degradation can occur especially in wet environment especially when it is highly acidic. However, of most concern is biological degradation. Biological agents that decompose wood are mainly fungi (brown, white and soft rots), insects (termites, beetles) and bacteria.

The main type of bacteria of concern is the cell-wall-degrading bacteria, which attack wood by erosion, tunneling, and cavitation. Little is known about the influence of different environmental factors on bacterial decay, but in general they seem more tolerant of cold temperature or low-oxygen conditions than even soft-rot fungi. They are often observed under water and are responsible for most of the microbial degradation of sunken ships, but are also know to occur in the terrestrial environment (Blanchette, R. A., T. Nilsson, G. Daniel, and A. Abad. 1990. Biological degradation of wood. In Archaeological wood: Properties, chemistry, and preservation, ed. R. M. Rowell and R. J. Barbour. Advances in Chemistry series 225. Washington, D.C.: American Chemical Society. 141-174). However, there is no evidence of bacterial degradation of wood under completely anaerobic condition.

Under anaerobic condition, three types of macro molecules, namely proteins, carbohydrates, and lipids provide the main substrates for decomposition of organic matter. The first step is hydrolysis, which creates amino acids, sugar, fatty acids, respectively. Subsequent steps are acidogenesis, acetogenesis and methanogenesis. A suite of bacteria, each of them requires specialized range of environmental conditions such as suitable temperature range are needed to degrade the organic matter.

In comparison to carbohydrate/protein/fat, the anaerobic bacteria are unable to digest lignin because its complex polymer structure. For example, in biodigesters, practically all waste organic material can be digested except for wood. Indeed, a major difficulty in cellulosic ethanol production using woody raw material is how to remove lignin. Often, wood has to be pretreated by physical (heating) or chemical (acid) methods before fermentation. This is a major economic and energy cost for woody cellulosic ethanol. Even though resistance of wood to decomposition is an obstacle for bioenergy, here it is a key for preserving wood for carbon sequestration.

While creating anaerobic condition is one pathway to preserve wood for carbon sequestration, storing wood in dry or cold condition can also preserve wood semi-permanently because the fundamental biology that decomposers also need moisture and suitable temperature to thrive. The control of these 3 factors: oxygen, moisture, and temperature provides the basis for our methods in wood preservation on timescales long enough to contribute to removing atmosphere carbon dioxide for climate change mitigation.

### 1. Wood Sourcing Methods

Wood harvest and storage (WHS) projects can be classified based on where the woody material is sourced from. Two major categories are considered here, depending on whether the source is opportunistic (Type-A) or long-term and repeatable (Type-B).

### 1.1 Opportunistic Sources (Type A)

In the first type (TYPE A), woody material from opportunistic sources is collected, often with environmental co-benefits such as fire risk reduction and waste utilization. They are ‘low-hanging fruits’ limited by the availability of ‘waste’ wood. They are often one-time opportunities such as the utilization of urban waste wood. This method may have a potential of up to 2 Gt CO₂ per year globally. An opportunistic source of wood can be defined as “waste” wood (described in examples below) which value (carbon credit value+other co-benefits such as fire prevention+waste utilization, future usage−cost for transportation, treatment and storage) exceeds its value for other usages (such as making paper, lumber), when used for wood storage to obtain carbon credit.

Examples of this type are given below.

### 1) Forest Thinning (THIN)

Biomass from forest thinning for fire risk reduction and other purposes is used for sequestration. Fire suppression, such as in the US and Canada over last several decades, has left a large amount of dead vegetation. Combined with drought and insect infestation in the America West, this has led to more frequent and larger fires in recent years. The release of this carbon pool through catastrophic fires may become an important source to atmospheric CO₂ in the future. Collecting dead trees and burying them would reduce fire danger while creating a carbon sink.

### 2) Residue

Residues from forestry operations such as slash and woodchips. In many places, they are not utilized due to economic and other constraints. To the degree that nutrient depletion and other ecosystem functions are maintained, a portion can be buried for carbon sequestration. Furthermore, careful management enabled by the carbon value can support better ecosystem functioning.

### 3) Urban Waste

Biomass from urban tree removal, construction site tree removal, demolition and furniture wood. These are often a burden and may be costly to dispose. Collect and bury this biomass for carbon sequestration can completely reverse the cost equation.

### 4) Recovery

Recover trees from storm blowdown and other natural or unnatural disasters and store the carbon will prevent the release of this carbon into the atmosphere.

Restrictions on these sources include the following:
1) Exclude wood with significant fungi colonization, which may continue decomposition after burial.
2) Exclude wood that is not fully intact or that is already partially decomposed (USFS decay class 1 as defined in Russell et al. 2014 allowed—all other decay classes not allowed).
3) Exclude wood that is or has been infested by insects such as beetles.
4) Exclude wood that has a stem diameter less than 10 cm, and that has a long-axis length of less than 1 meter.
5) Exclude phytoremediation biomass grown on brown field and mining recovery sites.
6) Exclude wood sprayed with herbicides or insecticides during management and collection.
7) Exclude biomass grown on lead contaminated soil from urban sites.

Two additional streams are not recommended at present if they are destined for well-managed landfills, based on their baseline:
1) Construction and demolition debris.
2) Old furniture and other wood products.

Suitable material for storage shall be selected based on size and wholeness of wood with minimum exposed surface area, to improve the efficacy of wood storage.

As before, consideration of baseline use of wood is paramount. Attestation and documentation could include letters from professional foresters, cooperative extension advisors or faculty, or local environmental regulators responsible for waste management within the jurisdiction.

Once the source of residual wood has been identified and contracted, the next step is to redirect it to the site of the Wood Vault. Transportation using fossil fuels will reduce the total credit volume of the project. It is critical to keep an accurate account of the carbon emitted in acquisition and transport.

Once the woody biomass arrives at the facility, it must be inspected for purity of composition. Only clean woody biomass can be buried without contaminants such as food scraps, toxic chemicals and heavy metals. Rocks, sand and gravel, non-organic soil, non-reactive cement and waste concrete are allowed provided evidence of no adverse effect on the stored wood but cannot be counted towards removed carbon.

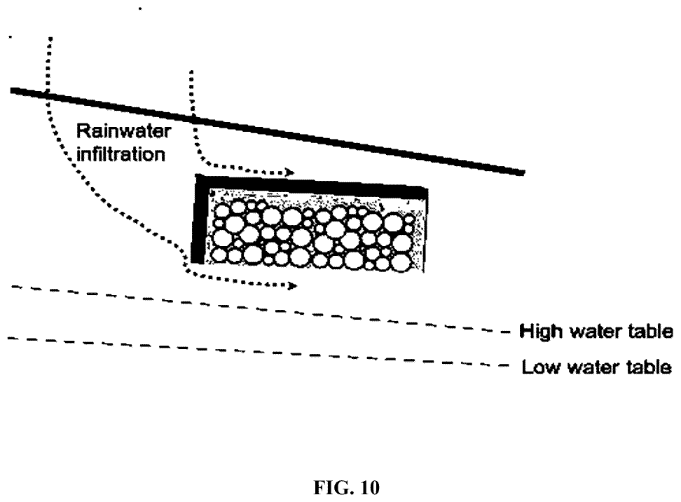

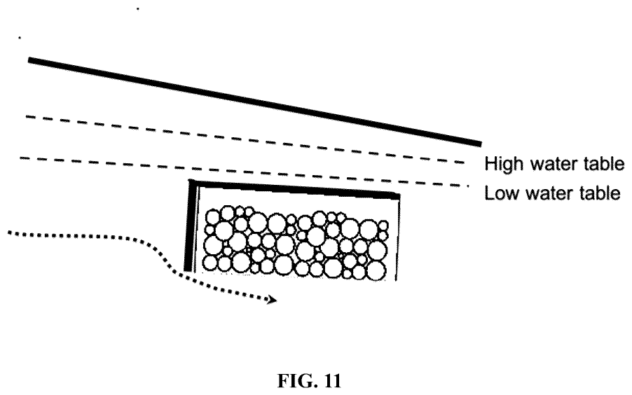

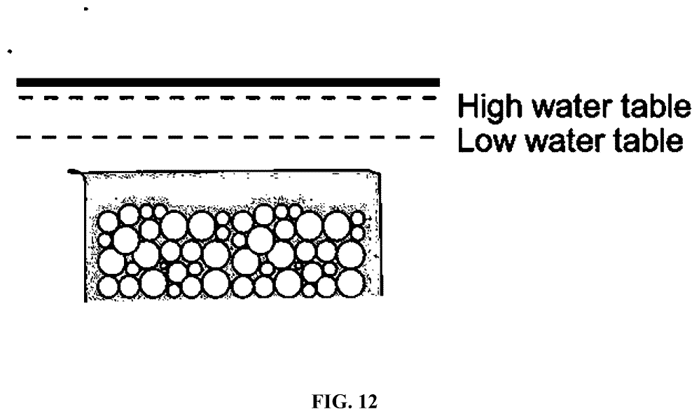

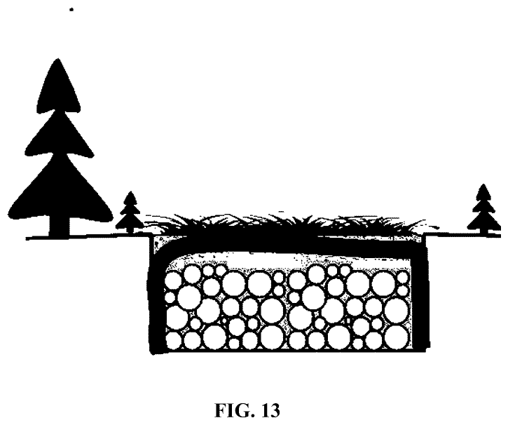

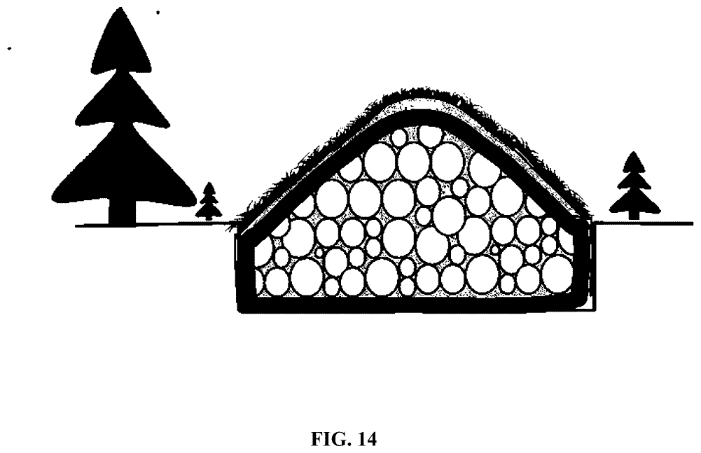

As illustrated in figures of the present disclosure, for example, FIG. 10, FIG. 11, FIG. 12, FIG. 13, and FIG. 14, Woody material should be sorted into Coarse Woody Biomass (CWB), i.e., trunks and branches with a minimum diameter of 10 cm or another widely accepted value, and Fine Wood Biomass (FWB), including small twigs, woodchips, and other finer material. Both CWB and FWB can be stored in the storage facility. In some embodiments, the FWB and the CWB are separated by a threshold of 5-10 cm in diameter. In some embodiments, pyrolysis tools are applied to make biochar out of the FWB. In some embodiments, biochar is used to fill the spaces between CWB logs to optimize space use efficiency while increasing total carbon use for sequestration.

The next step is to measure the sorted wood and calculate carbon content using direct weight measurements. Calculation based on volume is optional, providing useful information for stock management and vault construction. Follow these measurements with independent, third-party verification and reconciliation of any inconsistencies among multiple methods. Use the following formula to obtain CO₂e (CO₂ equivalent of carbon stored in wood) using the wood weight, water content, and dry-basis carbon content, multiplied by a factor of 44/12 (the molecular weight ratio of CO₂ and C):

$$CO 2 e = Weight of wood \times ( 1 - Water content ) \times Carbon content \times \frac{44}{12}$$

Variations in water content should be measured with calibrated instruments (e.g. moisture meters) and lab analysis (e.g. wet weight and dry weight) before summing up for CO2e in variable stockpiles.

Carbon content is typically 47-51% of dry matter and varies little among species (Thomas and Martin, 2012). When there is a lack of information, use the most conservative parameter values to estimate.

### 1.2 Sustainably Managed Sources (Type B)

In the second type (Type B), wood is harvested or collected directly from a growing forest, such as timberland and secondary-growth forest. The operation can be repeated every few years or decades and the carbon sequestered accumulates over time. Type B has large potential, up to 10 Gt CO₂ per year globally (about one third of global fossil fuel emissions).

### 1) Timber

Wood for carbon sequestration is harvested from a managed forest such as timberland. The forest is often privately owned, and has been used for timber, pulp for paper, biomass or bioenergy for many years. The sustainability and environmental impact of the forest are generally well established. Wood can be sustainably removed via thinning, rotation and other schemes. Carbon sequestration re-purposes or adds a new revenue to the original forest management objectives.

### 2) Nature-2

Wood is harvested from a secondary-growth forest, that is, a forest growing back from agricultural abandonment, degradation, fire or other disturbances. Such a forest goes through initial growth, followed by self-thinning, natural death, disease and other processes. Active management can lead to an overall more productive forest and better ecosystem service, while producing a carbon sequestration stream.

### 3) Restore

Manage forest land restored from degraded or marginal land for carbon. For example, tropical deforestation leaves land with poor quality after some years of grazing and agriculture.

Replanting new forest to take up carbon, followed by mixed use, including wood harvest and storage as an option can extend the initial carbon sink indefinitely.

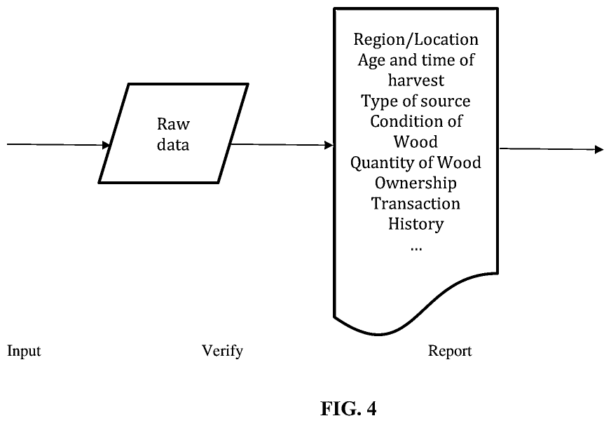

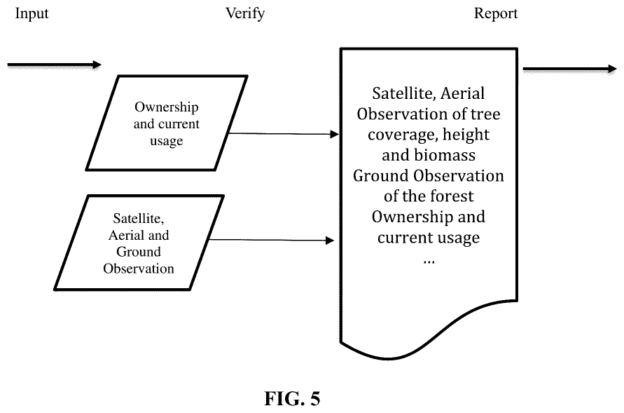

Whether a wood source is viable for WHS depends on the full carbon accounting. For both types of wood sourcing, net carbon gain can be calculated using total carbon gain, that is, stored carbon less lost carbon due operation, relative to a baseline. For type A projects, the baseline is simply that the wood would decay if business-as-usual. For type B, the baseline is a live forest that follows a natural or managed state. The net carbon gain, which is a function of time, determines the feasibility, value and timing of operation of the project. These are illustrated in FIG. 4 and FIG.5.

As shown in FIG. 4 and FIG. 5, source of wood used for storage and optimizing wood can be determined:
1) For type A opportunistic wood source, as shown in FIG. 4, the source will be traced and documented to ensure the authenticity of its origin and any co-benefits claimed are real.
2) For type B project, intelligent systems for sensing, monitoring, and methods for analysis can be used effectively for achieving the objectives, including the Internet of Things, Wireless Sensor Networks, Internet of Trees, Deep Learning, etc. As shown in FIG. 5, managed forest will be monitored with multiple methods, including:

Satellite observations of tree coverage, height and biomass, validated by ground observations; other targeted aerial observations from airplane or drone can also be applied; ground observation with modern optical methods such as AI-assisted analysis of optical and infrared images.

Software can be developed together with individually based forest models to estimate biomass and forest health in general.

Cell phone apps can be developed for initial quick estimate of forest status.

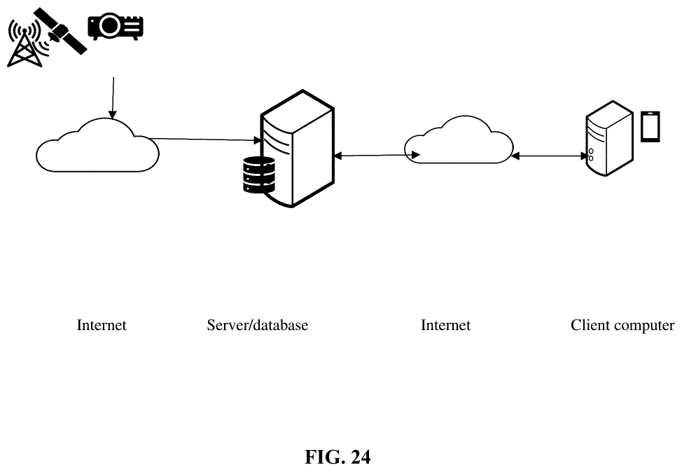

As shown in FIG. 24, A network-based system for wood sourcing monitoring for sustainably managed wood sources can be developed, includes:
1) a central processer accessible on a computer network.
2) at least one sensor in communication with the central processor, wherein each of the at least one sensors is operably associated with one of the at least one wood source assets, the sensor being configured to transmit wood source information relating to the at least one wood source asset to the central processor.
3) a client processor in communication with the central processor, the client processor configured to allow for inputting of wood source information, wherein the wood source information comprise at least at least one of a ownership information, current usage of the forest.
4) a GIS integrated wood source inventory database in communication with the central processor, the wood source inventory database configured to store:
a) satellite and ariel observations of tree coverage, height and biomass.
b) ground observation with modern optical methods such as AI-assisted analysis of optical and infrared images.
c) information inputted from the client processor.
5) software developed together with individually based forest models to generate a report designed to estimate biomass of at least a portion of a forest and provide information for determining the sources of wood for a wood storage project.
6) cell phone apps developed for initial quick estimate of forest status.

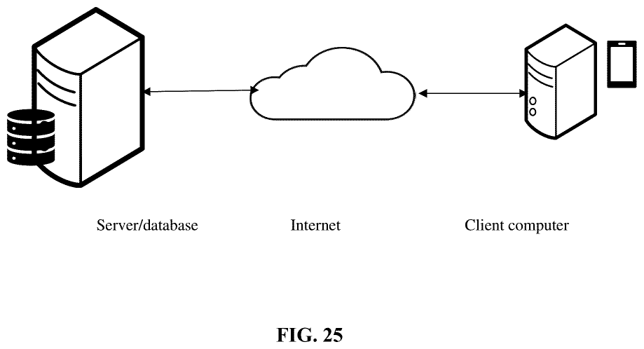

As shown in FIG. 25, A network-based system for wood sourcing for opportunistic wood sources can be developed, in which the source will be traced and documented to ensure the authenticity of its origin and any co-benefits claimed are real, includes:
1) a central processer accessible on a computer network.
2) a client processor in communication with the central processor, the client processor configured to allow for inputting of wood source information, wherein the wood source information comprise at least at least one of a source location, age and time of harvest, type of source, condition of wood, quantity of wood, ownership transaction history.
3) a GIS integrated wood source inventory database in communication with the central processor, the wood source inventory database configured to store:
a) source region and location.
b) age and time of harvest.
c) type of source (forest residue, yard waste, demolition debris, etc.).
d) condition of wood.
e) quantity of wood.
f) ownership transaction history.
4) software associated with the central processor configured to generate a report that can be used for determining the source of wood for a wood storage project.

Carbon accounting will be based on calculating carbon gain of the WHS project compared to a baseline. Wood harvest and storage (WHS) projects can be classified based on where the woody material is sourced from.

### 1.3 Carbon Accounting for Type A Project (Waste Wood as Source)

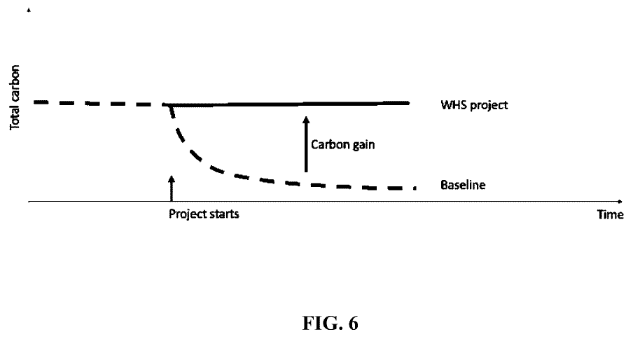

In the first type (TYPE A), wood is sourced from opportunistic sources such as urban waste wood disposal. As shown in FIG. 6, the carbon gain for carbon credit is ‘avoided’ carbon emissions relative to a baseline.

Woody material from opportunity sources is collected, often with environmental co-benefits such as fire risk reduction and waste utilization. They are ‘low-hanging fruits’, limited by the availability of ‘waste’ wood. They are often one-time opportunities such as the utilization of urban waste wood. This method may have a potential of up to 2 Gt CO₂ per year globally (Zeng et al., 2012).

First, a baseline is established. The baseline includes an assessment of the lifetime of the source wood. While decomposition (or none) of stored wood is continuous, we can choose two timescales: half-life time and 5% decay time (95% stored), but other timescales can be chosen as well. For example, whole tree logs on the forest floor have a half-life time ranging from few years in tropical rainforest to many decades or longer in boreal forest, depending on local climate and environmental factors. Similarly, waste wood such as furniture have similar timescale in open dumps.

Lifetime of buried wood is then assessed based on the storage method and environmental conditions. The lifetime can be broadly classified into a few categories: 1) stop-gap (<20 years), 2) short-term (20-100 years or a few decades), 3) long-term or semi-permanent (100-1000 years), and 4) permanent (>1000 years).

A model can then be developed as a single parameter model such as exponential decay.

$$C = {C}_{0} exp ( - \frac{t}{τ} )$$

where C is the carbon pool size with initial value C₀, t is time and τ is the e-folding decay time scale. Depending on material and environment, some may be better modeled using multi-parameter model with more realistic/sophisticated formulation, for example, a distributed model:

$$\frac{dC}{dt} = J ( t ) - {\int }_{0}^{τ} J ( t - τ ) Γ ( τ ) d τ$$

where Γ(τ) is a gamma function and J is a continuous input added wood to the carbon pool. The parameter values will be based on the life-time estimates. The model can then simulate continuously evolving carbon gain at any desired time interval. This carbon gain will then serve as the basis for carbon accounting and carbon credit. In the semi-permanent storage methods described here, the lifetime of stored wood is much longer than baseline, the carbon gain approaches the amount of stored carbon on climate-relevant 100-year timescale because wood typically decays in few decades or less in the baseline.

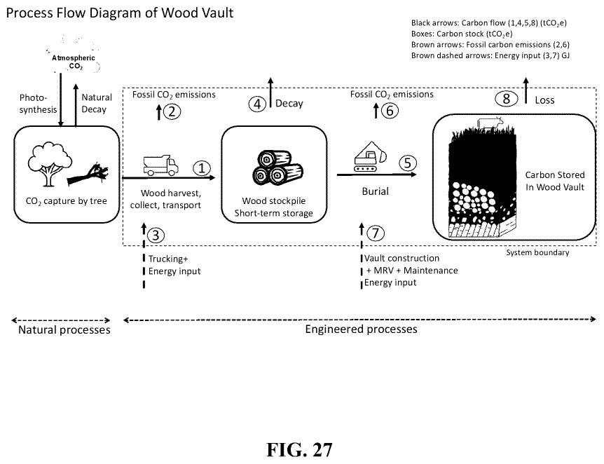

Strict carbon accounting is essential to ensure high-quality projects. The process flow diagram as shown in FIG. 27 lays out the primary operations involved in Wood Vaults and sets the system boundary for life cycle analysis (LCA), including the key aspects of Wood Vault construction and operation: the supply chain, system boundary, and baseline uses of biomass.
1) Collection and transport of biomass from source to burial site.
2) Storage of the biomass on site temporarily before burial in order to accumulate enough material. This may not be needed if sufficient quantities are available at once.
3) Construction and maintenance of the vault, operations to bury the wood, and ongoing monitoring and maintenance.

Carbon accounting requirements include baseline, or counterfactual specification, and full life cycle analysis (LCA) within a specified process boundary. FIG. 27 is a process flow diagram (PFD) of a Wood Vault, including both biologically derived carbon, fossil fuel CO₂ emissions and energy flow from machine operation. Process boundary here starts from collection and transport of wood residuals, and ends at durably stored carbon in the vault. The process flow diagram lays out the primary operations involved in Wood Vaults and sets the system boundary for life cycle analysis (LCA), including the key aspects of Wood Vault construction and operation: the supply chain, system boundary, and baseline uses of biomass.

The net carbon sequestration (NCS) of the full life cycle process is:

$$NCS = {C}_{init} - {C}_{Loss} - {C}_{Emis} - {C}_{LU} - {C}_{Baseline}$$

Where Cᵢₙᵢₜ is the volume of carbon initially stored in the Wood Vault, C_{Loss} is the loss of carbon stored over time, C_{Emis} is carbon emissions of machine operation, C_{LU} is the carbon loss from land-use change and soil disturbance at the burial site and associated facilities, C_{Baseline} is the baseline carbon storage. Note that many of these terms are time dependent including loss, land use and baseline.

The process boundary is used for tracking carbon for life cycle analysis purposes. Carbon that enters the project boundary is considered stored (sequestered) while carbon exiting the process boundary is considered fugitive (lost or returned). As such, it is a key factor when determining the scale, efficiency, and success of a sequestration project.

The process boundary depicted in FIG. 27 shows how the hybrid biological-engineering approach of WHS takes advantage of photosynthesis byproducts, followed by engineered storage. For projects using wood residuals, the process boundary starts from wood collection. The NCS depends on wood sourcing, wood collection and wood vault construction & operation. The LCA must therefore account for all carbon emissions within this boundary.

In a standard project the process boundary is the project site, storage or holding site, burial chamber, and transport vectors from wood residual creation to the site. Sequestration occurs upon burial and is discounted by direct greenhouse gas (GHG) emissions from the project site as well as carbon released from biomass acquisition and transport.

### 1.4 Carbon Accounting for Type B Projects (Continuous Sources From Managed Forest)

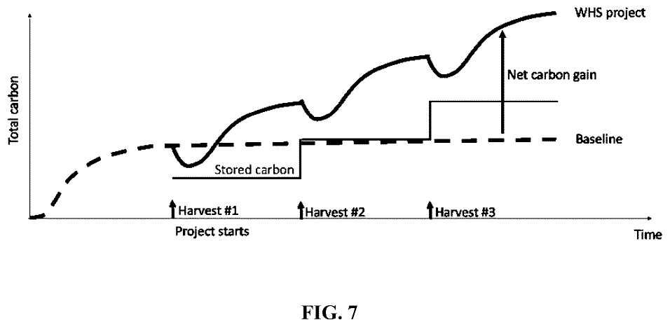

In the second type (Type B) projects, as shown in FIG. 7, wood is harvested or collected directly from a growing forest, such as timberland and secondary-growth forest. The operation can be repeated every few years or decades and the carbon sequestered accumulates over time. Type B has large potential, up to 10 Gt CO₂ per year globally, about one third of global fossil fuel emissions (Zeng et al., 2012).

This type of project involves more complex accounting upstream because the sustainability of the wood sources is a critical aspect.

Immediately after harvest, the forest may be a small carbon source because some material may be left on the forest floor for nutrient recycling, and the carbon will be released back to the atmosphere in relatively short amount of time. There may be additional loss in handling. It is only after a while when new trees grow, the recovered carbon pool plus the stored carbon will exceed the carbon of the original pool. This carbon gain is the net carbon sequestered. If selective cutting or collection of downed wood is the main operation, the initial loss would be small or negligible. The full carbon credit of the stored carbon should not be given immediately, but rather be given over time, in line with the regrowth uptake. Investors can choose upfront investment with discounted value. The time-dependent carbon accounting proposed here will be critical for the long-term success of the strategy.

Life cycle analysis (LCA) will be conducted, with the aid of carbon cycle model for the full accounting of each kind of operation. Parameters and input of the analysis will be based on carbon cycle models that simulate forest growth for the specific species, calibrated with biomass growth data. The net carbon gain, that is, the stored carbon plus regrowing forest, subtract the baseline forest will be used as the basis for carbon credit.

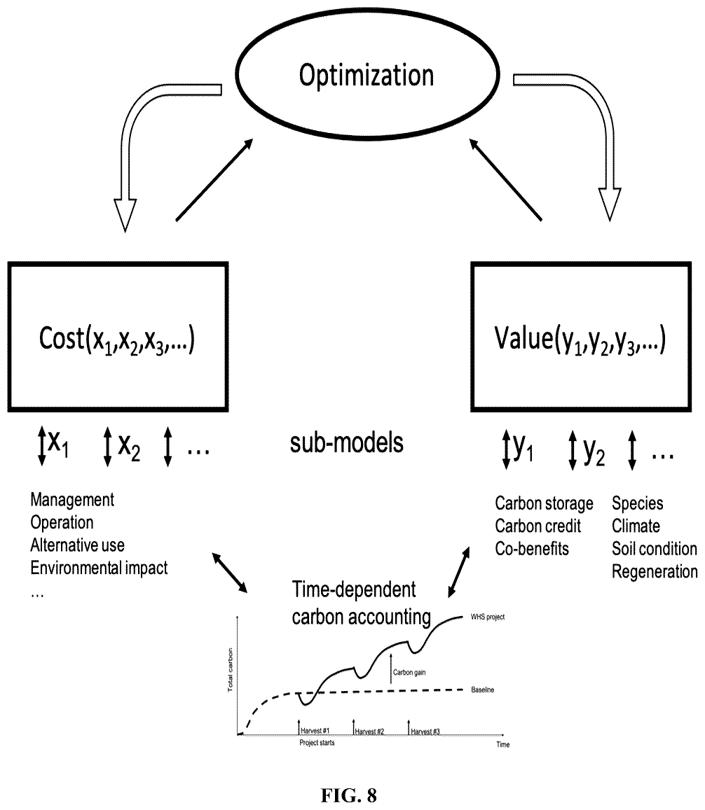

Forest is a precious resource that provides a multitude of ecological functions as well as many human demands such as timber, furniture and paper making. In the context of climate change, biomass in live trees and active soil stores carbon. A key innovative aspect of wood harvest and storage is to use trees as carbon ‘pump’, not just carbon storage. Because of the limited land area, carbon sequestration competes with other wood use. Nevertheless, studies have shown large potential in sequestration. Optimization methods are used for decision making. FIG. 8 illustrates a method for cost optimization in wood sourcing disclosed by the present disclosure.

For example, for a forest landowner, the optimization will provide the best option for deciding whether to use the forest for timber, paper pulp, carbon sequestration or other usages. If for carbon sequestration, it provides a tool for deciding planting-harvesting frequency in order to optimize the carbon sequestered. As another example, for a storage facility manager or owner, the optimization will provide the best choice for deciding the size of the facility versus area for sourcing wood.

Mathematical models are thereby developed to optimize the wood sourcing and storage problem for carbon sequestration. The basic principle can be expressed as a method to minimize a cost function J:

$$J ( x , y ) = J ( {x}_{1} , {x}_{2} , {x}_{3} , … , y 1 , y 2 , y 3 , … )$$

where x=x₁, x₂, x₃, . . . is a vector of multiple factors that impact the cost of sourcing wood, while y=y₁, y₂, y₃, . . . is vector defining the total value of the forest, including value of the sequestered carbon, or alternative use for lumber or paper, each with its own value proportional to the amount allocated to that particular use. For example, for a timberland owner who needs to determine whether or how much the source can be diverted for carbon sequestration, these factors include the land area, forest age, the carbon stored as a function of time in live biomass, carbon stored in storage, the lifetime of stored biomass, harvesting frequency, cost of harvest, cost to the environment due to different strategies, cost of transportation and storage. Another important factor is the cost of transportation to storage facility. For waste wood sources, the cost of disposal vs. cost of transportation. The optimization provides multiple perspectives for different stakeholders in the process, for example, owner of a forest, storage facility operator, owner of waste wood, government from environmental or job point of view.

One of the more complex factors is carbon storage in time relative to a baseline or other wood use methods.

y₁=y₁(species, climate factors, harvest frequency, regeneration strategy, fire prevention . . . ).

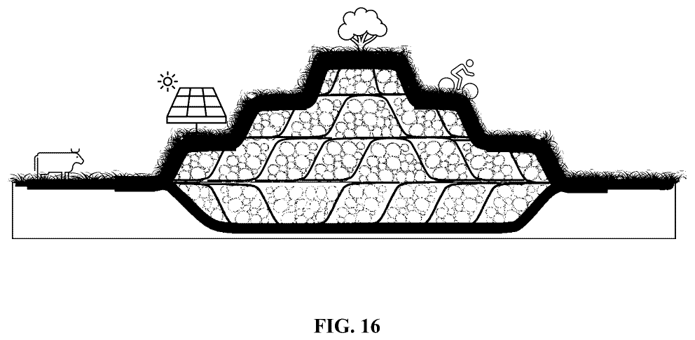

This can be calculated using semi-empirical forest growth models, or more complex carbon cycle models. FIG. 16 illustrates the result from such a modeling method. In another approach, forestry gap models can be used to simulate multi-species multi-age forest stand, useful for selective cutting strategy and better forest management.

The optimization procedure then uses the input of different usages and parameter values to find the best overall value relative to cost, that is, to minimize cost J. In simplified versions, this can be solved by taking the derivative of the cost function zero.

$$\frac{\partial J}{\partial x} = 0 , \frac{\partial J}{\partial y} = 0$$

Given the complexity of the underlying models and processes, the optimization problem is best solved numerically. Iterative methods can be used to allow different sub-models to converge. Measurements of the growing forests or stored carbon can be merged with predictive model using data assimilation technique. This technique combines mechanistic model of forest growth with the data to obtain best estimates of carbon pool size as a function of time. Model parameter values such as photosynthesis rate dependence on soil moisture and temperature are perturbed based on their uncertainties. This generates an ensemble of possible model states (forecast) evolving in time.

The data assimilation inputs are the observation y⁰, the ensemble forecast xₖ^{b}(t)=M(xₖ^{a}(t−1)) with mean value and the forecast of the observation. M represents the full nonlinear model, k is the index for model ensemble member, h is an ‘observation operator’ that ‘maps’ model prediction onto observation space in order to compute the observation model error covariance. This is an ensemble square-root filter in which the observations are assimilated to update only the ensemble mean while the ensemble perturbations are updated by transforming the forecast perturbations through a transform matrix:

$${\overline{x}}^{a} = {\overline{x}}^{b} + {X}^{b} {{\tilde{P}}^{a} ( {HX}^{b} )}^{T} {R}^{- 1} [ {y}^{0} - h ( {\overline{x}}^{b} ) ]$$

$${X}^{a} = {{X}^{b} [ ( K - 1 ) {\tilde{P}}^{a} ]}^{1 / 2}$$

Here K is the total number of ensemble members, X^{a}, X^{b} are perturbation matrices whose columns are the analysis and forecast ensemble perturbations, respectively. X^{b} is updated every analysis time step, therefore the forecast error covariance

$${P}^{b} = \frac{1}{K 1} {X}^{b} {X}^{{b}^{T}}$$

is flow-dependent. \tilde{P}^{a}, the analysis error covariance in ensemble space, is given by

$${\tilde{P}}^{a} = {[ ( K - 1 ) I + {( {HX}^{b} )}^{T} {R}^{- 1} ( {HX}^{b} ) ]}^{- 1}$$

which has dimension K by K, much smaller than both the dimension of the model and the number of observations. Thus, the algorithm performs the matrix inverse in the space spanned by the forecast ensemble members, which greatly reduces the computational cost.

The final analysis product that describes the best estimates of carbon density as a function of time, taking into account of measurements and known carbon dynamics. It can then be used for the cost-value analysis above.

### 2. Wood Storage Method

Wood Storage methods include: 1) Burial under soil; 2) Above ground storage in shelter, warehouse, lining, thin soil, and other cover-in methods; 3) Submerge under water; 4) Dry condition; 5) Cold condition; 6) Combinations of above. The preservation of wood for hundreds of years or longer timescales relevant to climate change can be practical. A key factor is to maintain extremely low oxygen level, achievable through burial under low-permeability soil or submerged under anaerobic water body. A concern of possible methane genesis by anaerobic bacteria is relieved because wood, unlike carbohydrate, is resistant to such bacteria who do not attack lignin. Sub-zero temperature and very dry conditions may also be suitable as biological activities are very slow under such conditions. Storage above ground in such as shelters, warehouses, and simple covers are also feasible, but will require more maintenance. To be practical, a major constraint is the economy of operation and maintenance. Within the constraints of practicality and cost, semi-permanent or permanent conservation of wholesome wood is generally preferred for both climate benefits and possible future alternative use as biomass raw material or biofuel.

Because the key to a successful Wood Vault is to create anaerobic conditions that prevent decomposition, carbon durability critically depends on the low permeability seals to ensure atmospheric oxygen does not enter the burial chamber. For 1000+ year durability, a minimum thickness of 1 meter of material with permeability less than 10⁻⁸ m/s (as measured by saturation hydraulic conductivity) or equivalent is required. This defines a base decomposition rate which is the inverse of the decay time scale.

We developed the following formula to describe the factors influencing the rate of decomposition of stored wood, namely moisture, temperature, oxygen level, and surface area:

D=D₀D₁(w)D₂(T)D3(O)D4(A)

where D₀ is the basic decomposition rate that is tree species dependent, while D1-D4 are relative or normalized. The decomposition rate D is function of moisture w, temperature T, oxygen level O, and total surface area of buried wood A. These functions can be highly nonlinear and they can interact. For instance, at low moisture, decomposition rate is slow, then increases at higher moisture, but at extremely high moisture, i.e., water-logged condition, the interaction with oxygen then leads to reduced decomposition. While different mathematical functions can be used to model these behaviors, they need to represent the general relationships. Here, a set of specific forms is proposed.

For moisture dependence,

$${D}_{1} ( w ) = \frac{{d}_{0} + exp ( - {( \frac{{w}_{0} - w}{{w}_{1}} )}^{{n}_{1}} )}{{d}_{0} + 1} , if w \leq {w}_{0}$$

$$= \frac{{d}_{0} + exp ( - {( \frac{w - {w}_{0}}{{w}_{2}} )}^{{n}_{2}} )}{{d}_{0} + 1} , if w > {w}_{0}$$

For temperature dependence,

$${D}_{2} ( T ) = exp ( - {( \frac{{T}_{0} - T}{{T}_{1}} )}^{{n}_{1}} ) , if T \leq {T}_{0} = exp ( - {( \frac{T - {T}_{0}}{{T}_{2}} )}^{{n}_{2}} ) , if T > {T}_{0}$$

For both temperature and moisture dependence, the decomposition rate is small at low values, but reaches an optimal value of w₀ or T₀, and decreases at high values. This represents the general biological behavior that has an optimal condition at intermediate environmental conditions.

For dependence on oxygen level (O), we use a logistic function,

$${D}_{3} ( O ) = \frac{{O}^{α}}{{O}_{0}^{α} + {O}^{α}}$$

where O₀ is ambient oxygen concentration at 21%, and α determines the sensitivity at extremely low oxygen values when decomposition rate is slow. The oxygen level itself depends on a range of conditions, in particular the hydrological state and how well the material is sealed.

Because the physical protection, the interior of a whole log is less accessible to decomposers. If the log is chopped into woodchips, the surface area would be much larger. Thus the ‘wholesomeness’ of the material is also an important factor. We formulate this as a dependence on exposed surface area A,

$${D}_{4} ( A ) = {( \frac{A}{{A}_{0}} )}^{b}$$

where, A₀ is the surface area of the original whole raw wood logs. Woodchips have a total surface area much larger than logs (A>>A₀) for the same mass, thus is more likely to decompose. Decomposition rate here is mass loss rate, and D₄ is relative to that of whole log. The exponent b represents the impact of effective surface area, and it is less or equal to 1. The exact value depends on how compact the material is, densely packed woodchip in clay soil would have less exposed effective area, thus smaller exposed surface area.

There are other factors such as acidity (pH), alkalinity and salinity that are important for preserving materials such as bone and metals as in archaeology, but are considered of minor influence for clean wood preservation in natural environment, and are not considered here.

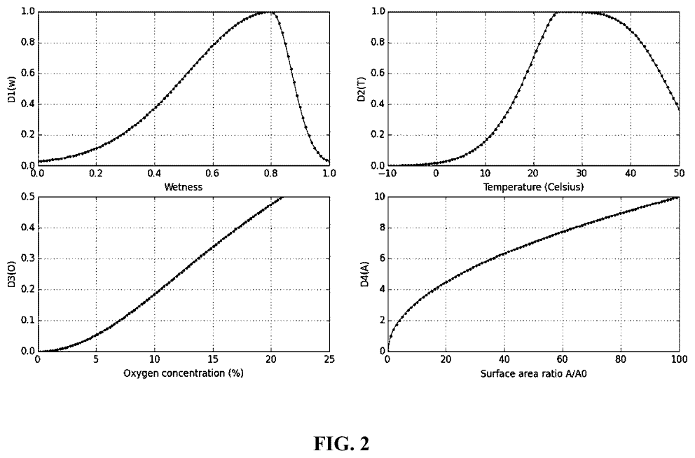

These functions are shown in FIG. 2 for representative parameter values.

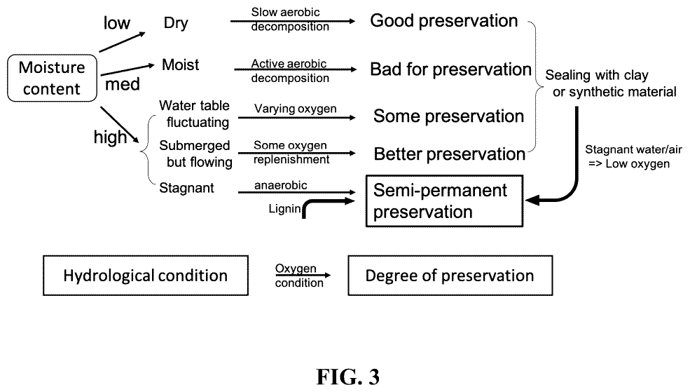

This formula can be used to determine the methods of wood storage for a variety of conditions, taking into account interaction of these factors. For example, in desert region, moisture is low, one can then choose a method that requires less protection such as no clay, and simple above ground storage. In the other extreme, when moisture is very high, the site becomes water-logged which is also favorable for preservation. In this case, the goal is to maintain the water-logged condition by preventing drying. A critically important consideration is how moisture condition influences oxygen level as illustrated in FIG. 3. Understanding of such interaction serve as the basis for the proposed storage methods described by the present disclosure.

Once the decomposition rate is determined, the evolution of stored carbon can be predicted with a simple exponential decay model:

$${C}_{store} ( t ) = {C}_{init} exp ( - \frac{t}{τ} ) ,$$

where t is elapsed time, τ is the decay time which can be calculated as the inverse of decay rate D obtained from equation

$$D = {D}_{0} {D}_{1} ( w ) {D}_{2} ( T ) {D}_{3} ( O ) {D}_{4} ( A ) : τ = \frac{1}{D} .$$

The lost carbon is:

$${C}_{Loss} = {C}_{init} - {C}_{store} = {C}_{init} ( 1 - exp ( - \frac{t}{τ} ) ) .$$

Theoretically, τ is a continuous function of factors in Equation D(w,T,O,A)=D₀*D₁(w)*D₂(T)*D₃(O)*D₄(A). In practice, we recommend assessing durability at several timescales: 100, 500, 1000 and 10000 years, in consideration of the hundreds of years needed for a meaningful carbon sink and climate impact.

The durability timescale τ must be initially estimated after careful evaluation of the vault construction material, environmental condition and engineering details. Different components of the wood have different degradability, for instance between wood extractives, or chemicals found in wood, and the main lignocellulose component. Extractives such as sap account for typically less than 10% of wood biomass, which we conservatively assume would be degraded in a few years, and is subtracted from subsequent accounting.

For the remaining lignocellulose fraction, use the 4 durability timescales specified above. Using Equation

$${C}_{store} ( t ) = {C}_{init} exp ( - \frac{t}{τ} ) ,$$

carbon remaining (Cₛₜₒᵣₑ) after time t=τ_{neutralization}=100 years, a commonly used climate timescale, for the 4 durability timescales is calculated in the table below:

Decay time scale τ (years)

| | 100 | 500 | 1,000 | 10,000 |
|---|---|---|---|---|
| Carbon remaining | 37% | 82% | 90% | 99% |
| (Cₛₜₒᵣₑ) after 100 years | | | | |
| Recommended buffer | 68% | 23% | 15% | 6% |
| pool (Loss + 5%) | | | | |

We require sites to measure and report durability based on their ongoing MRV operations. Until durability is measured, reported, and verified, we recommend a fraction of produced credits be placed in a buffer pool. This buffer pool is the expected loss plus additional 5% of initial carbon for security. The final recommended buffer pool, as a fraction of total carbon storage in the Vault at time of burial, for different durability time scale τ is listed in Table above.

We recommend an initial 68% buffer pool, corresponding a minimum τ=100y. After proof of higher durability, credits can be released after verification. For example, if verified to be τ=500y, the fraction difference of 45% (68%-23%) between the two durability scales can be released from the buffer.

In summary, the above buffer pool specification constitutes an assurance of the specified fraction should the project meet a minimum τ=100y. Credits held in the buffer pool are released only when assessed and verified as stored.

### 2.1 Burial Under soil

### 2.1.1 Basic Methods

A key factor to ensure the longevity of stored wood is to reduce oxygen. If done well, the buried wood is considered permanently stored (>1000 years, and at least hundreds of years).
Soil texture: Low permeability, such as clay.
Hydrology: avoid water level fluctuation and water flow; place wood in either a) always under the water level, i.e., below the water level of the dry season, or b) always above the water level, i.e., above the water level at the wet season.

If neither of the above is satisfied, source clay soil from somewhere else to completely enclose the buried wood: bottom, top and all sides.

If none of the above is satisfied, have soil layer on top as thick as practically possible (one to several meters). The permanence of the buried wood will be reduced, but may still be accepted as semi-permanent (>100 years). High permeability soil such as sand and gravel should be avoided (<100 years, temporary storage).

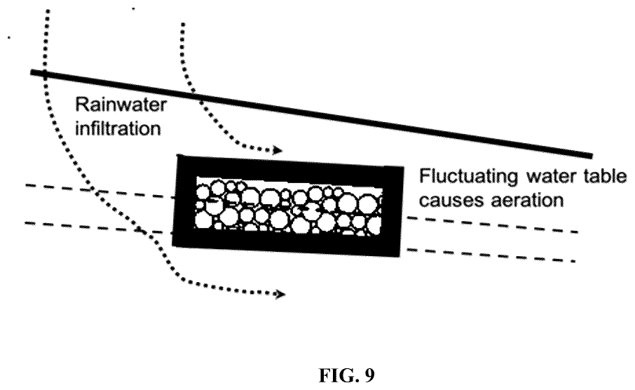

A few typical situations are described below, with special attention to hydrology impacting oxygen level. Keeping the water stagnant by sealing with clay or synthetic material can significantly extend the lifetime by reducing the chance for oxygen replenishment and maintain extremely low oxygen level.
1) Burial chamber fully sealed in clay that is 0.3 meter or thicker, synthetic liner, or other impermeable materials (FIG. 9). In the worst-case scenario, water table fluctuates through the wood pile which can cause aeration and oxygenation. The burial needs to be sealed from all sides with clay or other material.

At coastal areas threatened by sea-level rise, the storage facilities can be built by burying woody biomass underground, refilling soil on top, and regrading surfaces of the selected coastal areas into higher structures than original flat low land, to create varying topography, enhancing biodiversity while controlling sea level rise. In some embodiments, Logs can be mixed with mud in construction of structures comprising at least one of dikes or sea walls, and to enhance strengths of the structures while storing carbon, Logs should be completely wrapped inside the mud of at least 1 meter thickness in all outer directions. In some embodiments, logs can be embedded in soil or cement in a pattern, Logs should be completely wrapped inside the soil or cement of at least 0.5 meters thickness in all outer directions. In some embodiments, the pattern comprises a crisscrossing pattern to meet a mechanical requirement of a construction structure. In some embodiments, tree logs can be directly pumped into ground vertically as foundations for constructions. In some embodiments, we can parameterize soil or dirt and select the soil or the dirt based on the parameterization to optimize the carbon sequestration in the storage facilities. In some embodiments, the foundations of existing construction structures can be raised by pushing down the tree logs after building the existing construction structures. In some embodiments, straight and long logs can be selected for raising the foundations.
2) Burial underground, above the highest seasonal water table (FIG. 10). In such a place, water table is significantly below surface so there is enough depth above for wood storage. The main thing here is to avoid rainwater infiltration that brings in oxygen. Sealing the top and upslope side may be needed.
3) Burial underground, below water table, but there is significant lateral flow due to topographical gradient or other causes as happens in mountainous, piedmont, or undulating hilly regions (FIG. 11). Sealing of upslope side is preferred to divert the flow around or below the burial pile.
4) Burial under stagnant water (FIG. 12). Water table is close to surface, and the water is stagnant due to flat topography. This happens usually at low land area. Sealing may not be needed for permanent storage, though it is still safer if low-cost clay or silt is available for sealing.

### 2.2.1 In-Situ Burial Methods

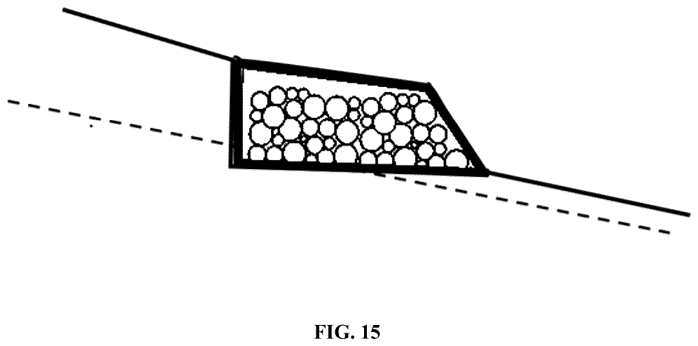

This applies to in-situ collection and burial on the forest floor (FIG. 13 and FIG. 14). It is distributed. The cut or collected wood can be hauled with a forwarder to the burial site, and usually does not involve trucking the logs for long-distance. Because the need to seal the site before significant degradation, each site will have limited size compared to the large-scale facilities discussed later.
1) The buried wood should be either completely under the lowest water table of dry season, or completely above the highest water level during wet season.
2) If the soil has very low permeability such as clay, it may be allowable to have the buried wood subject the seasonal water table fluctuation, but its permanence will be reduced somewhat.
3) The low permeability may be achieved by using clay sourced somewhere else, which would increase the cost. The cost may be significant as individual burial trench is small but still needs sufficiently amount of clay on the sides, thus expensive per unit of biomass buried. This method is more economical for large facilities.
4) Anoxic storage facilities can be built in low permeability soil with minimum saturated hydraulic conductivity of less than 10⁻⁸ m/s for at least a meter, topped with original topsoil to allow fully functioning biological activities in the topsoil.
5) If none of the above is practical, have soil layer on top as thick as practically possible (meters).
6) Use liner on the upslope side of water flow when significant.
7) Burial above ground or semi-above ground on a slope (FIG. 15). The up-slope side is cut to create room for wood burial. Soil is piled back on top. Because of the slope, the result is a terrace or sloping terrace. Sealing on top and the upslope side is recommended.

### 2.2.2 Large-Scale Burial Facility for Above Ground or Semi-Above Ground Storage

To accommodate wood material of a variety of sources such as urban waste wood, forest residues, as well as logs collected from a broader region, large facilities can be built to handle the material efficiently. To construct such a facility (FIG. 16),
1) Firstly, estimate the sustainable rate of wood source from a region.
2) Then a suitable site is selected, with size commensurate the estimated wood source.
3) The suitability of the site is based on assessment of site characteristics, including topography, hydrology, climate, environment, economics and other relevant factors.
4) Then soil is excavated to form a large pit, with the soil laid on the side. The organic containing topsoil (organic containing) should be excavated first, separate from lower-level soil, and put back in at the last on the surface, to minimize providing nutrients and substrate for decomposers.
5) The pit will be divided into multiple sections (cells). To minimize any degradation before the closure of the cell, wood material is trucked over and laid down in the cell before moving on to the next cell. After fully filled, the section is covered with a layer of soil and closed. The cell size is such that it can be filled, ideally in less than a year of the first dump, and the shorter the better. The optimal cell size can be determined by balancing wood sourcing rate and engineering cost (larger cell will be more space efficient and cheaper per unit mass of wood stored). Different quality material should be separately buried in different cells as they may have different durability, for example, logs, woodchips, old furniture should be separated.
6) Wood material, especially woodchips can be pre-treated to extend the storage lifetime. For example, the treatment material can be contained inside a pond on site. Woodchips can be dipped into the pond, packed into easy-to-handle units after or before treatment. The preserves for treatment can be wax or other commonly used wood preserving chemicals. Woodchips can also be charred with a charcoal-making process on site. Another technique is to spray over the wood, especially the cut surfaces.
7) Use the excavated local soil to cover the buried wood if it has low permeability such as clay. The permeability should be lower than 10⁻⁸ m/s, and preferably less than 10⁻⁹-10⁻¹⁰ m/s. If clay is not available on site, source it from somewhere else.
8) If covering soil is sourced from outside or the soil excavated is not reused for refilling or covering, wood can be simply piled up without excavation. This may be a preferred approach if the water table is very shallow and fluctuates significantly so that it's difficult to keep the buried wood outside the fluctuating zone.
9) Where the topographical slope is significant, line the upslope-facing side to prevent water from moving laterally through the buried wood, in order to minimize episodic reoxygenation of the burial environment.
10) The base of the pit should be above the local water table at its highest level to avoid fluctuating water-air boundary bringing oxygen.
11) If considering all factors for site selection, the water-level requirement (either completely above the seasonal highest water level or completely below the lowest seasonal level) cannot be satisfied, and the local soil does not have very low permeability, one can use clay to enclose the pit completely with sufficient thickness (greater than 0.3 meter, ideally 1 meter or more) on all sides.
12) After the facility is enclosed, grass or trees with shallow roots can be allowed to grow back, and the land can then be used as pasture for grazing animals, cropland, park, photovoltaic solar farm, or combination of the above.

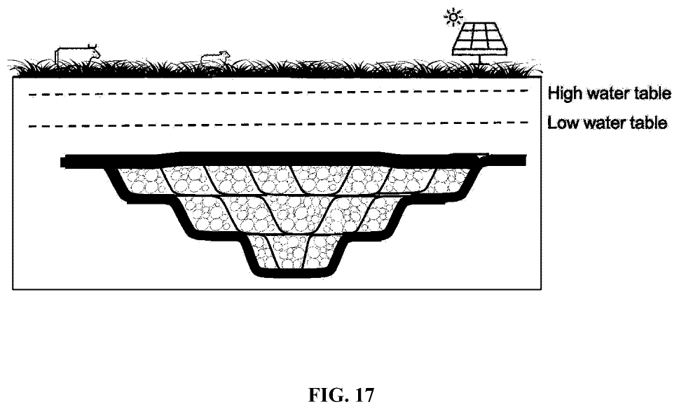

### 2.2.3 Large-Scale Burial Facility for Storage Underground

Where water table is near surface, the wood can be buried completely underground below the lowest level of fluctuating water table (FIG. 17).
1) Such places are typically low-lying land with also little lateral transport, so sealing with clay may not be necessary. These places also tend to have silty soil as they are formed by alluvial/fluvial sedimentation.
2) In the case of a valley, there may be strong one directional flow. In this case, upslope direction should be lined with clay or synthetic liner to minimize water flow in the burial chambers.
3) Similar methods can be applied to bury in abandoned mine.

### 2.3 Above-Ground Storage in Shelter

Above-ground storage facilities can be built to store wood. They can be either large-scale facilities that collect wood from a wider area, or small to medium size in-situ facilities that collect wood from the local harvest.

### 2.3.1 Large-Scale Centralized Shelter Facilities

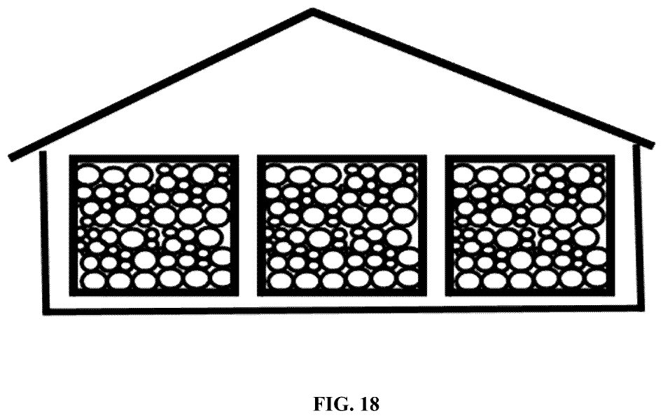

These are warehouse-like structures that shelter the wood from rain, wind and other elements (FIG. 18). Inside each shelter, cells consist of scaffolding-like holding structure made with metal or wood posts are built to hold logs or woodchip stacks. There is space in between cells to allow loader to pass. The loaders may be electric battery powered like fork-lift. As an example, the dimension of each pile can be 10-meter width, 10-meter height, and 10-100 meter length, with 5 meter spacing in between piles (cells). Clearly, other reasonable designs are also possible. Multiple shelters can be built at the same site, with each shelter housing many cells.

Fire-resistant synthetic liners are used to cover each individual cell. For best preservation, each pile is sealed by bonding/melting/gluing pieces of covering liners together to form an air-tight enclosure. Sealed cells will soon be devoid of oxygen as it gets consumed quickly by only a small amount of decomposable organic matter in the pile.

Alternatively, a layer of soil can be used to cover up the logs instead of synthetic material. Soil has the advantage of been naturally fire-resistant. It may be messier to handle than synthetic material and may be more expensive to maintain. The soil is best reinforced with cut straw or other material, similar to traditional mud house. Clay is preferred as it is stronger when dries. Other soil types should work too.

Because such a facility is regularly monitored, any structural degradation such as peeling of soil wall (or damage in synthetic cover) can be repaired.

In such a managed state, woodchips can potentially be kept almost as well as whole logs. It also lends itself to pre-treatment, for example, dipping into wax or other protective material before storage.

### 2.3.3 In-Situ Shelter

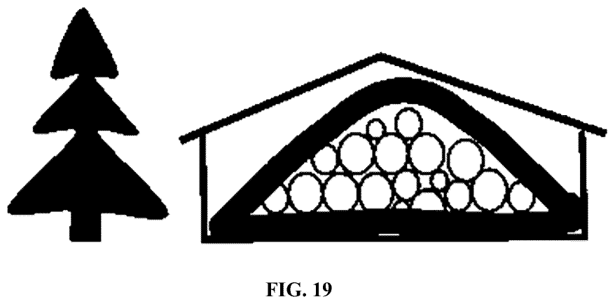

Above ground in-situ shelter can be made. As shown in FIG. 19, Synthetic material can be used, Alternatively, soil layer can be used. Unlike large-scale facility, the shelter could be a simple roof to shelter out rain. Everything can be made with local organic material. Metal structure and synthetic cover can also be used. Maintenance may be required on multi-year timescales as damage inevitably occurs. The choice will depend on the balance of structural stability, cost and environmental consideration.

Compare to in-situ mound structure method, wood inside the in-situ shelter is completely above ground. Mound burial can of course also be all above ground, in which case soil will come from somewhere else (surrounding or exported from far).

### 2.4 Underwater Storage

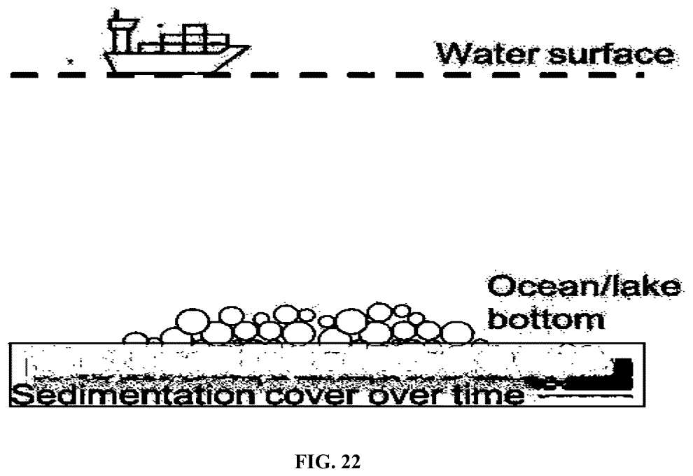

As shown in FIG. 22, wood can be stored under water. Water body contains much less oxygen than air, and with the lack of major wood decomposers like white rot fungi, water provides an environmental for wood preservation. However, for the climate timescale of hundreds of years or longer, additional measures will be needed to ensure wood preservation. Stagnant and anaerobic water bodies will be best, while flowing water will need special treatment.
1) Bottom of stagnant water bodies. Examples include the Black Sea, the Great Lakes. Logs are collected from surrounding regions, rafted or transported to the water body and sink to the bottom. For logs that are lighter than water, weights such as rocks may be tied to the logs and help them sink to the bottom. In stagnant water with also high sedimentation rate, the logs will also buried in silty sediments after some years, creating an excellent condition for preservation.
2) Water bodies with less ideal condition for wood preservation. As marine borers and other organisms may attack wood, protection will be needed. Wood logs can be grouped into large bundles and wrapped in synthetic liners and sink to the bottom with weight. While the bundles can be initially sealed, it may be difficult to guarantee that it does not break after a long-time. The cover should still nonetheless provide significant protection to slow down possible decomposition.

To determine whether a water body has very low oxygen, oxygen sensors can be used to measure the oxygen level at the bottom. Sedimentation rate can also be measured. Such data are then used to determine the suitability.

### 2.5 Dry Storage

Wood can also be stored in dry regions such as desert or semi-desert. The requirement for additional protection, either above-ground shelter or underground burial will be significantly less demanding than in wet regions. A main limitation is wood availability as wood will be transported from other regions or closer-by mountains. In some circumstance this may be viable. Dry storage facilities are built to maintain bone-dry condition with relative air humidity of less than 10%.
1) Above ground shelter, either large-scale or small scale as described above. Given that wood likely comes from somewhere else, large-scale facility may be most cost effective.
2) Underground. Because low water content and movement, simple burial with local soil may be sufficient to keep the wood semi-permanently. As desert soil tends to be shallow due to slow weathering, mound may be a more practical method for storing sufficient amount of wood in each enclosure. Mound also has the advantage of drain occasional rainwater away more efficiently. Similarly, as for above ground shelter, large-scale facility will be more cost effective.

### 2.6 Cold Storage

Because of the extremely slow decomposition rate in sub-freezing condition, wood can be stored in permanent cold regions, for example, the coastal regions of Antarctica.

Wood will be sourced from different regions. Wood is collected, bundled, and transported to ports. Transportation can be done by rafting down river networks or by trucks or trains. The wood bundles are loaded onto container ships/barges at the ports, then shipped to Antarctica. Shipping cost to Antarctica is not necessarily formidable because of the efficiency of today's trans-oceanic shipping. Typically, trans-oceanic container shipping costs only 1/20^{th} of on land trucking. Most cost and carbon footprint can be sufficiently low. Once at Antarctica, the wood bundles are unloaded and piled up from the ground. The location should be solid ground, not part of the icesheet or iceshelf to avoid ground movement.

### 2.7 Combination

Any combination of above can be made to take advantage of multiple factors, for example, bury in dry regions can lead to even more permanent storage, or compensate for weaknesses in permanence and cost.

### 2.8 Economics of Storage Facilities

### 2.8.1 Wood Collection for Large-Scale Storage Facility

Large-scale facilities are particularly suitable for diffused wood sources. Opportunistic sources are not reliable individually. However, over large enough area, there will be a near steady supply for a large facility.

As an illustrative example, we consider an area of 1000 km² (100,000 ha), typical size of a county in the eastern United States, for example, 1290 km² for Prince George's County, Maryland. How much wood is available sustainably from such a region? We start from a wood availability of 1.1 tC/ha/y, based on a modest sustainable harvest rate for temperate forest, which is about 10% of a temperate forest's annual net primary production (NPP; Zeng et al., 2012).

Even though waste wood sources vary widely, on long time scale and over large enough area, it is still fundamentally constrained by sustainable wood production rate. We also made the assumption that significant fraction of the land is wooded, which is not unreasonable, especially because urban trees can be used this way when they are removed. If the region has major wood imports or exports, this assumption will need to be adjusted. Where wood is already in major demand for lumber and pulpwood, this potential is reduced. However, residues from such operation can be utilized for carbon sequestration, and other potential sources such as small forest plots may become available when there are economic incentives that are otherwise unused. We note that if wood from plantation, especially fast-growing species, significantly higher rate can be achieved.

The wood availability of 1.1 tC/ha/y corresponds to approximately 4 t CO₂ or 4 tonne of wet biomass per hectare per year. Over the 1000 km² region, 400,000 tonne of biomass each year is available. After 10 years, a total of 4 MtB could be collected.

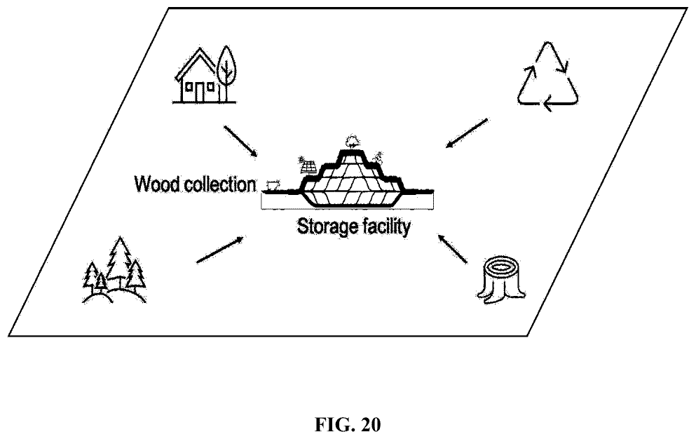

FIG. 20 illustrates a centralized wood storage facility collects from variety of sources such as natural waste wood from surrounding region.

### 2.8.2 Size of Large Storage Facility

What size of a large-scale burial facility will be needed to accommodate this amount of wood? 4 Mt of biomass has about 4 million cubic meters of volume. This volume can be of dimension 40 ha×10 m (area×height), or a taller one with smaller area 10 ha×40 m. 40 ha (100 acre) is the typical landfill property size (for example, 50 ha for Brown Station landfill, Prince George's County, Maryland), can thus accommodate the wood collected in the area of the county for 40 years. Given that the shape of the burial space is tapered (smaller upward for above-ground hill-style, and smaller downward underground for below ground pit), 40 m is an average height/depth. Also consider some extra space needed for soil filling, the top of the hill will be somewhat taller than 40 m. There is no fundamental reason a hill cannot be made this tall, which would provide a nice vista point on flat land and recreational space if used as a park after sealing off. If desired, it can be made lower but with a larger base area to bury the same amount of wood. A few smaller hills can also be made on the same site with same management.

In summary, an area of 40 ha (typical landfill size) can bury 16 Mt of wood, collected from the surrounding area of 100 km² (typical county size in the eastern US) over a period of 40 years. The resulting ‘hill’ or ‘pit’ would occupy a total volume somewhat larger than 40-hectare area by 40-meter height (100 acre by 130 feet). Several stages of burial should be conducted at shorter time interval, say every 5-10 years to seal off the already buried wood.

It is also possible to use a similar size facility to bury wood collected from a larger area, for example the surrounding counties. In this case, the facility can be filled to capacity within 10 years. The additional cost of transporting wood material over longer distance, for example within 100 km may still be quite economical. The optimal size of the wood burial facility needs to strike a balance between size of wood source region and the cost of facility construction and transportation, depending on the local circumstances.

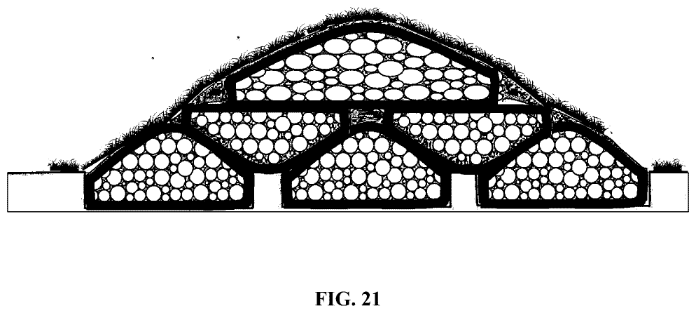

Finally, several such facilities can be built on the same site next to each other. Additionally, it is also possible to build more on top and in between existing ones (FIG. 21 illustrates a super-size facility consisting of multiple burying units built horizontally and vertically on top of each other), This will increase overall height. This will enable the facility to run much longer beyond a few years. The overall cost will also be lower and save space to create new facility.

### 2.8.3 Economics of Large Facility

On 40-hectare of land, with a hill more than 40 meters tall or a ditch similarly deep, an effective internal space of 16 million cubic meters can store 16 Mt of woody biomass. At a carbon price of $50/tCO₂, the value for 16 Mt CO₂ is $800 million. The construction of the facility would cost $10-50 million. Should the wood source come from wood harvest for carbon sequestration, the cost would be $14/tCO₂ (Zeng, 2008) plus transportation for a total of $20/tCO₂ assumed here. Further including other costs such as land and facility management, it could have more than 50% profit margin. It is important to note that, for waste wood source, even in the absence of carbon price, disposal of wood is already economically viable as revenue is enough to pay itself via tipping fee.

TABLE 1
Cost breakdown of a prototype large facility
that collects and stores 16 Mt biomass.

| | | | | Wood | Wood |
|---|---|---|---|---|---|
| | | Construc- | Opera- | source | source |
| | Land value | tion | tion | (waste) | (harvest) |
| Unit cost | $10,000/acre for | | | −$1 to 0 | $20/t |
| | 100 acre | | | | |
| Total cost | 1 | 10-50 | 10? | −16 to 0 | 320 |
| (million | | | | | |
| USD) | | | | | |

TABLE 2
Economics of a prototype large facility on a
carbon market. One tonne of wet biomass corresponds
to approximately 1 t CO₂ sequestered.

| Biomass | Land area of | | Value of carbon credit |
|---|---|---|---|
| stored | storage facility | Cost | at $50/tCO₂ |
| 16 | 40 ha (100 acre) | $21-341 | $800 million |
| million | | million | |
| tonnes | | | |

### 2.8.4 Economics of in-Situ Small Facility

In-situ storage on the forest floor, near the logging land site, or on the roadside where wood is harvested has the advantage of minimizing transportation cost and other benefits. A disadvantage is the cost of moving machinery to the site and other overhead costs of each operation. It may be most efficiently carried out by a company that goes around a larger area consisting of many smaller sites with multiple ownerships. Materials and machinery can be planned out and used most efficiently.

### 3. Wood Treatment Method

Before storage, wood can be treated with chemical and physical methods through pressure treatment, liquid preserves or charring before wood is stored to prolong the preservation time.

Preservatives are the chemical which enhances the durability of timber treated with different methods. The following characteristics of preservatives are the most important: High toxicity towards wood destroying organisms; Permanence in the treated wood; Ability to penetrate deeply in wood; Freedom from deleterious effects on the wood itself; Without harmful effects on the operatives and those who handle the treated wood.

The effectiveness of the preservative treatment depends not only on the nature of the preservative but also on the amount taken up per unit area of the wood. This may be achieved by selecting the appropriate method of treatment of wood. There are five types of treatment method can be used: pressure method, brushing/coating method, dipping method, spraying method and sap-replacement method.

### 4. Project Evaluation, Monitoring and Verification

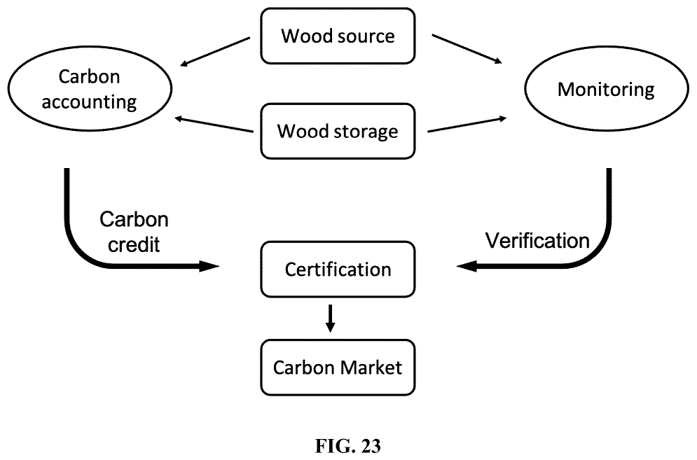

FIG. 23 is a diagram illustrating a system for carbon accounting, certification, and carbon credit transaction according to an embodiment of the present disclosure, wherein, monitoring and verification of both wood sourcing and storage will ensure the net carbon value.

### 4.1 Storage Project Evaluation and Monitoring

A project is assessed and evaluated in the following categories of factors

The trench/mound burial condition will be evaluated based on several factors, including
1) the depth of the soil
2) the permeability of the soil
3) the infertility of the soil
4) the dimension of the trench
5) biomass and carbon content of buried wood
6) regrowth and maintenance condition on the surface (grass, crop, park, bare, etc.)

The surrounding burial site condition for preservation will be evaluated for the following factors:
1) site climatological temperature: annual mean and seasonal range.
2) site climatological humidity condition: soil moisture dry or wet, water-logged or not, water table, for both annual mean and seasonal cycle

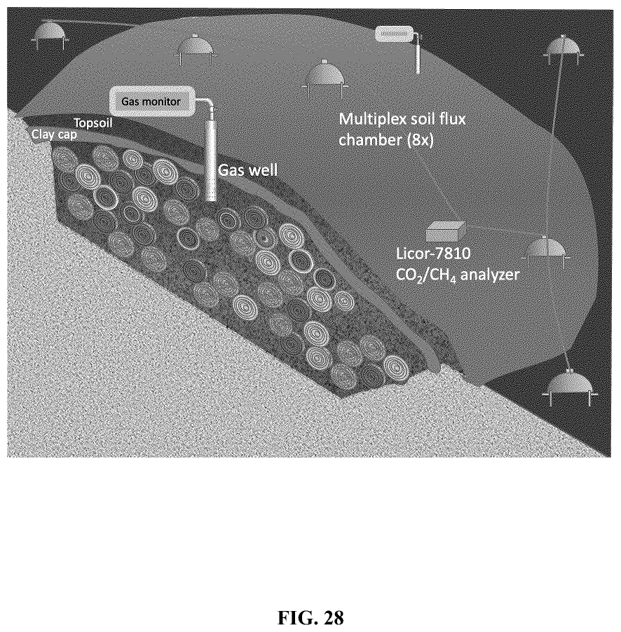

As shown in FIG. 28, For sample sites, sensors will be installed to directly observe underground oxygen level, temperature, moisture, as well as potential CO₂/CH₄ leakage rate etc. The site-specific data can be used to calibrate carbon accounting model parameters. The monitoring approach includes four steps:
1) Burial chamber interior gas monitoring: CO2, CH4, O2, pH, redox potential, dissolved O2, plus humidity, temperature, pressure with low-cost sensors (SENSE-W). Goal: Evolution and stabilization of the burial environment. In a well-constructed Wood Vault, CO₂ concentrations will initially increase while O₂ concentrations steadily drop as the leftover O₂ buried in the chamber is consumed by a small number of residual decomposers. Both will level off within weeks to months, with the final O₂ concentration settling towards zero, killing any remaining decomposers. Once these key variables settle into a demonstrable quasi-equilibrium with negligible methane emissions, the Wood Vault can be considered geologically stable. Monitoring should last at least several years. Once the geologically stable state is achieved, monitoring frequency can be substantially reduced. Any deviation from these trends means there is a problem with the Wood Vault and the sequestration may have been compromised. Determine what that problem is and redress it if possible. If it is not possible to redress, the project has failed. There are two types of sensor systems for monitoring: Periodic sampling followed by lab measurements. This typically yields results with higher accuracy. Continuous data collection with high temporal resolution down to minutes. This method minimizes sampling error in the presence of fluctuations and noise, but it may risk lower accuracy. Traditional soil and hydrological monitoring typically uses periodic sampling to reduce the cost of frequent field trips. Recent advancements enable continuous monitoring of gasses with smart low-cost sensors (Martin, et al. 2017). Some of these sensors transmit data instantly to the cloud using the Internet of Things approach (IoT). Redundant, in-situ, low-cost sensors should be supplemented by periodic sampling and lab analysis to verify the sequestration of all projects.
2) Surface flux monitoring for any CH4 leakage with Licor-7810 CO2/CH4/H2O analyzer and 8× multiplex system. Goal: ensure no CH4 leakage. To monitor potential methane generation and leakage, install instruments such as soil flux chambers to monitor flux of CH₄ and CO₂. The instruments must be mounted immediately after capping of the Wood Vault. One location should be where interior gas is most likely to accumulate and escape, such as at the top of a Tumulus dome. For comparison with baseline, instruments should be mounted both on the capped Vault and the undisturbed surrounding in order to detect the difference. Significant CH₄ flux originating from inside the burial chamber over a long period of time that cannot be neutralized by soil above is an indicator of Wood Vault failure.

A well-constructed Wood Vault creates an anoxic environment that prevents action of main decomposers of organic matter such as fungi and insects. This leaves only anaerobic bacteria which could potentially generate CH₄. However, methanogenic bacteria degrade lignin, a complex polymer that forms a protective layer in woody biomass around cellulose, at extremely low rates (Colberg 1998, O'Dwyer, Walshe, and Byrne 2018). Additionally, a Wood Vault buries only clean Coarse Wood Biomass (CWB), with relatively small amounts of nutrients to support a bacteria ecosystem. Thus, methane generation is expected to be minimal in a well-constructed Wood Vault.

There may be the exception of a small quantity of wood extractives that contain more digestible molecules such as saccharides and protein. Should this component become methane, the rate is expected to be low and mostly oxidized into CO₂ by methanotrophs (bacteria that consume methane) in the aerobic topsoil layer above should it slowly migrate upwards (Bay, et al. 2021). This process is further slowed because the coarse woody material physically hinders bacteria invasion into the interior (Bjordal, Daniel, and Nilsson 2000). However, before all these are fully established and quantified empirically in the real-world Wood Vault burial environment, direct measurement of potential CH₄ leakage or the lack of is important.

If the Wood Vault is not well constructed or sealed, a partially anaerobic condition can generate methane. If a substantial amount of nutrient-rich material such as foliage is present, CH₄ generation could become a concern as the foliage degrades anaerobically. In this case, methane capture can be attempted as a mitigation strategy, but the methane generated may be at an intermediate rate that is too small to be effectively captured (unlike a landfill where a large quantity of methane is generated from bacterial consumption of food scraps, even in which case leakage is common), and too large to be consumed by soil bacteria in the aerobic zone. The methane emissions can be calculated with the greenhouse effects deducted from carbon accounting. In severe cases where the leakage is so large as to render the net carbon accounting not worthwhile, the Wood Vault is considered failed. This guide requires the burial of only clean coarse woody biomass with total anaerobic sealing that is expected to have negligible leakage to the atmosphere. Monitoring procedure is required to ensure this is the case.

One or more processing circuits are used to simulate gas concentrations, migration of gases and water and air in their horizontal and vertical movement, including transport via advection and diffusion in 3D numerical models. The 3D numerical models simulate distribution of biomass and gases including at least one of wood, O₂, CO₂, or CH₄, and bio-chem-physical processes that govern sources and sinks of the biomass and the gases, and diffusion/transport through soil layers. The 3D numerical models can further simulate pH, and ORP redox potential (ORP). Then the 3D numerical models are calibrated and validated with experimental data. The 3D numerical models are further configured to simulate gases and H₂O dynamics within the storage facilities and also processes along soil profiles to surface where greenhouse gases of CO₂ and CH₄ are emitted.

The 3D numerical models further comprise a model of transport, diffusion, with sources and sinks:

$$\frac{\partial C}{\partial t} = - v \cdot ∇ C - \frac{\partial {F}_{x} ( C )}{\partial x} - \frac{\partial {F}_{y} ( C )}{\partial y} - \frac{\partial {F}_{z} ( C )}{\partial z} + Sources - Sinks .$$

Based on the above 3D numerical models, with one or more processing circuits, a carbon accounting can be performed including: establishing a baseline including an assessment of lifetime of the sources of wood based on time scales including a half-life time, and a 5% decay time; assessing a lifetime of buried wood based on storage methods and environmental conditions, wherein the lifetime of the buried wood is classified into stop-gap (<20 years), short-term (20-100 years), semi-permanent (100-1000 years), permanent (>1000 years), and ultra-permanent (>10000 years); constructing a single-parameter model:

$$C = {C}_{0} exp ( - \frac{t}{τ} ) ,$$

wherein C is a carbon pool size with an initial value C₀, t is time, and τ is an e-folding decay time scale, or constructing a multi-parameter model:

$$\frac{dC}{dt} = J ( t ) - {\int }_{0}^{τ} J ( t - τ ) Γ ( τ ) d τ ,$$

wherein Γ(τ) is a gamma function and J is a continuous input added wood to the carbon pool with parameter values based on the assessed lifetime.

Using the one or more processing circuits applying the single-parameter model or the multi-parameter model, a continuously evolving carbon gain at a specified time interval can be simulated and the simulated continuously evolving carbon gain can be displayed to users with one or more display screens.
3) Re-excavation and analysis of samples. Goal: Direct analysis of state of preservation. Another MRV technique is to excavate and retrieve samples of buried woody biomass and analyze the status of preservation. This is considered a definitive answer to the durability question and should be conducted for all medium to large scale projects in the present state of scientific and practical knowledge. Repeat this entire process every 5-10 years for the first 50 years, and every 25 years afterwards. For this process, excavate a representative cell or section of the Wood Vault. Make sure to keep the topsoil and low permeability capping material separate from any other earth and woody biomass excavated. Ensure that the sides and floor of the cell are not interfered with or damaged in the excavation. Collect a small amount of woody biomass from a variety of depths, then return the rest of the excavated woody biomass and earth to the burial chamber. For the baseline capping process, reseal the top of the Wood Vault with the same low permeability material used in the initial capping, potentially acquiring new material if the integrity of the initial cap is compromised. Finally, take the original topsoil and recover the surface of the Wood Vault. Once the woody biomass has been excavated, take it to a qualified lab for analysis. Measure the following parameters for samples from every recovery depth and plant species in the sample batch: Visual and microscopic examination, Density, Mechanical Strength, Chemical composition of wood (lignin, cellulose, hemicellulose), Carbon Content, Water Content. Significant loss inconsistent with the stated durability/permanence is an indicator that something has gone wrong. If it occurs, begin an investigation into whether sequestration has failed.
4) Monitoring soil settlement, Wood Vault integrity and site management. Goal: long-term overall environmental impact assessment. After some initial soil settlement to adjust to the pore space in the burial chamber, long-term settling is an indication that decomposition may have occurred. Some initial soil settling is inevitable after the final capping of a Wood. The degree of settling depends on initial space and the settlement may take a few years. Follow these steps to monitor soil settling and the overall Wood Vault integrity:
Step 1: Estimate the initial space in between the buried woody biomass, subtracting the portion filled during soil backfill.
Step 2: After enclosure of the Wood Vault, conduct a survey of the ground surface. The survey can be done using a traditional standard survey technique or aerial/drone technology.
Step 3: Build a 3-dimensional model of the Wood Vault, with accurate information of its geometry, location of woody material, pore space vs. wood ratio, and other relevant data.
Step 4: Repeat the survey annually until settlement is deemed complete.
Step 5: Compare the survey data from multiple time periods to determine whether soil has completely settled which is expected to occur within 10 years in most conditions. Cross check the data with gas monitoring of the burial chamber interior. Soil settlement that significantly exceeds the initial void space, or major settlement after 10 years is an indicator of loss of woody biomass or major hydrogeological change and can be an indicator that further investigation is required.
Step 6: During each survey, document the general integrity of the Wood Vault and the environment above and surrounding the Wood Vault, including vegetation, land use and management. Use the 3-D Wood Vault model to quantify any change. Check against the original management plan, convey and reconcile any discrepancy to the relevant parties.

The burial site environmental impact factors include:
1) Disturbance to the site: ecological functioning; stability of soil; impact on hydrology such as loss of riparian buffer.
2) Reduced or enhanced value for other use. ‘Eye sore’ if close to community, in which case mitigation strategy will be developed. A positive example is to build a park on top. Yet another positive example is the reclamation of abandoned mines that are used for wood burial.

Disturbance refers to an external disruption of the stored carbon, exposing it to fresh air and oxygen, or otherwise compromising sequestration. Disturbances come in two forms:
1) Human interference
2) environmental change

In a human interference scenario, human activity compromises the sequestration of carbon, for instance, deliberate re-excavation or subterranean construction. These activities are strictly prohibited in any Wood Vault conservation easement. Preventing them is a matter of enforcement and depends on the specific conditions of the specific Wood Vault project.

Environmental change refers to the compromise of sequestration due to external environmental factors. This includes natural disasters and climate change. Natural disasters are relatively straightforward. Earthquakes, hurricanes, floods, and similar events can disrupt the structural integrity of a Wood Vault. The risks of such events can be mitigated by minimizing the exposure of a Wood Vault site to such events. Disaster propensity is a key factor to analyze in location selection.

A deduction is applied to net sequestration based on the emissions accrued during woody biomass acquisition and Wood Vault construction. The GHG emissions should be tracked from the following sources and then subtracted from net sequestration:
1) Transportation of woody biomass
2) Transportation of off-site materials such as imported clay
3) Creation of off-site materials
4) Woody biomass collection, preparation, sorting
5) Vault excavation
6) Woody biomass burial
7) Vault sealing
8) Project related travel energy consumption and carbon footprint
9) Monitoring and verification
10) Site maintenance

From there, the sum of the fossil fuel consumption of all the above activities can be found via use of greenhouse gas emissions factors.

$${C}_{emis} = {\sum }_{i} Fuel Consumption ( i ) \times Emission Factor ( i )$$

where i represents each activity of operation. The use of emissions factors allows operators to reduce their emissions through use of electricity or biofuels.

Land use changes can release above ground and below ground carbon back into the atmosphere. As such, any disruption in vegetation and soil carbon caused by Wood Vault construction is subtracted from the sequestration total. Before the Wood Vault construction begins, developers must conduct a survey of the carbon stocks contained in the area that will be occupied by the Wood Vault and associated facilities. From there, this value is subtracted from the sequestration total. Then, during each monitoring period, a similar survey should be conducted of the region's carbon stocks. Any changes since the last survey should be added or subtracted to the sequestration total as appropriate.

$${C}_{LU} = Land Carbon ( current ) - Land Carbon ( initial )$$

To estimate the volume and durability of the carbon sequestered, establishment of a baseline is required. This means analyzing what would have happened to all carbon within the project boundary and comparing it to what would have happened to said carbon without any intervention.

For operating wood vault burial chambers, the baseline is that the residual woody biomass would decompose and all the carbon stored within is emitted back into the atmosphere as CO₂ within several years (decomposition or burning). The simplest approach is to assume an exponential decay with a characteristic time scale τ_{baseline} based on the circumstance (decompose on forest floor, burned, etc.).

$${C}_{baseline} ( t ) = {C}_{init} exp ( - \frac{t}{{τ}_{baseline}} )$$

Suggested values of τ_{baseline} are as follows:

| Baseline | τ_{baseline} |
|---|---|
| Left to decompose on forest | 20 y |
| floor | |
| Mulched | 5 y |
| Burned | 1 y |

We assess carbon storage at a minimum of 100 years. Within this time frame, wood residual would have nearly all been released back into the atmosphere in most baseline scenarios. This simplifies accounting. In the other direction, some more resistant components such as lignin and burned residue may have much longer residence time that should be accounted with more sophisticated models in the future. More precise accounting accounts for impacts of environmental variables and wood characteristics using the general form of equation D(w,T,O,A)=D₀*D₁(w)*D₂(T)*D₃(O)*D₄(A) with specific functional forms and parameter values suitable for the wood source baseline environment.

Measuring the amount of carbon captured and sequestered relies on life cycle analysis (LCA); an LCA study involves establishing baselines and conducting a thorough inventory of the energy and materials required by all the processes involved in capturing and sequestering the carbon and calculating their corresponding GHG emissions to the environment. An LCA assesses cumulative potential environmental impacts and is conducted only for processes within set system boundaries.

FIG. 27 describes the processes and carbon flow that need to be accounted for. The descriptions above list the specific calculations for each factor to be considered. Follow through those steps to complete the LCA analysis, with final net carbon sequestered (NCS) using equation NCS=Cᵢₙᵢₜ−C_{Loss}−C_{Emis}−C_{LU}−C_{Baseline}.

In summary, the project developer must provide full carbon accounting that include clearly defined process boundary, Quantity and durability of the stored carbon, Carbon loss over time and CH₄ emissions, wood sourcing dependent baseline, CO₂ emitted during machine operation, CO₂ emission due to land use change at the burial site, Net Carbon Sequestered on the specified durability timescale, Additionality justification.

Through the assessment of the above factors, both quantitative measures and qualitative criteria will be produced:
1) The amount of carbon sequestered.
2) An estimated longevity range of buried carbon in years. This will be expressed as 5% decay time and/or half-life time, synthesized using a process-based wood decomposition model that takes into account of the biology of wood decomposition and the preservation condition above as model parameters. The model, after been applied to past data under a variety of conditions as well as future anticipated project data, is expected to continue to improve and provide estimates with greater and greater confidence.
3) An environmental soundness indicator will be given as excellent, good, fair, poor.
4) Representative sites will be revisited at a regular frequency, typically once a year. The site will be checked for its maintenance and environmental impact. Measurement of underground condition will be collected, as well as direct sampling of buried wood and lab testing for its condition. Adjustment of model parameters and longevity estimates will be updated accordingly.

### 4.1.1 Main Categories of Evaluation Outcome

At the conclusion of project/facility evaluation, major categories will be reported as:
1) Carbon Stored: Large (>100,000 tCO₂); Medium-large (10,000-100,000 tCO₂); Medium (1000-10,000 tCO₂); Small (<1000 tCO₂).
2) Distributed or centralized storage.
3) Permanence: ultra permanent (>10,000 years), permanent (>1000 years); semi-permanent (>100 years); short-term (decades).
4) Cost: High (>$100/tCO₂); Medium ($50-100); Low (<$50).
5) Environmental and societal impact (source, operation, storage): beneficial; small negative that can be mitigated; modest impact; severe impact.
6) An environmental soundness indicator will be given to a project: excellent, good, fair, poor.

### 4.2 Certification

Based on the evaluation criteria above, certificate will be issued for projects that are considered viable. The amount of carbon sequestered will be quantified in unit of tonne of CO₂, via life cycle analysis (LCA) using monitoring data and full carbon accounting of both wood source and wood storage. More detailed information on the temporal change of net carbon gain will also be provided. The longevity of the sequestered carbon, environmental impact, co-benefits will be described, and categorical score will be given. An overall score/rating will be given. This information will allow carbon credit to be obtained. The carbon credit can then be exchanged on a carbon trading market.

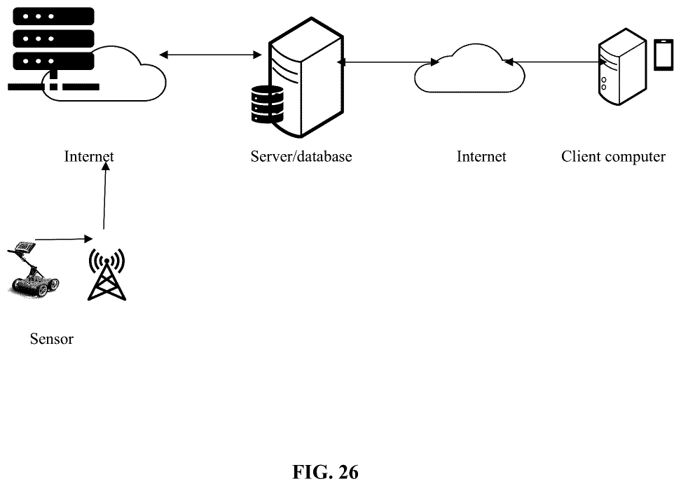

As shown in FIG. 26, A system for storage project evaluation and monitoring can be developed, the system comprising:
1) A central processor accessible on a computer network.
2) At least one sensor in communication with the central processor, wherein each of the at least one sensor is operably associated with one of the at least one wood storage assets, the sensor being configured to transmit wood storage information relating to the at least one wood storage asset to the central processor.
3) A client processor in communication with the central processor, the client processor configured to allow for inputting and downloading information from the server.
4) A wood storage inventory database in communication with the central processor, the inventory database configured to store:
A) The factors for evaluation of trench/mound burial condition including the depth of the topsoil, the permeability of the soil, the infertility of the soil, the dimension of the trench, biomass and carbon content of buried wood, regrowth and maintenance condition on the surface (grass, crop, park, bare, etc.).
B) The factors for evaluation of surrounding burial site condition, including site climatological temperature: annual mean and seasonal range, site climatological humidity condition: soil moisture dry or wet, water-logged or not, water table, for both annual mean and seasonal cycle.
C) Collected data for underground oxygen level, temperature, moisture, as well as potential CO2/CH4 leakage rate.
D) The burial site environmental impact factors including disturbance to the site: ecological functioning; stability of soil; impact on hydrology such as loss of riparian buffer; reduced or enhanced value for other use.
5) Software associated with the central processor, the software configured to generate a project report including the following information:
A) The amount of carbon sequestered: Large (>100,000 tCO₂); Medium-large (10,000-100,000 tCO₂); Medium (1000-10,000 tCO₂); Small (<1000 tCO₂).
B) Distributed or centralized storage.
C) Permanence: ultra-permanent (>10,000 years), permanent (>1000 years); semi-permanent (>100 years); short-term (decades).
D) Cost: High (>$100/tCO₂); Medium ($50-100); Low (<$50).
E) Environmental and societal impact (source, operation, storage): beneficial; small negative that can be mitigated; modest impact; severe impact.
F) an environmental soundness indicator will be given to a project: excellent, good, fair, poor.
6) Certificate will be issued for projects that are considered viable. Of certified projects, the amount of carbon sequestered, longevity/durability of the sequestered carbon, environmental impact, co-benefits will be described, and categorical score will be given. An overall score/rating will be given.
5. Carbon Credit Accounting and transaction for wood storage project

As shown in FIG. 26, A network-based wood and carbon storage monitoring, accounting and transaction system can be developed, the system comprising:

[symbol]

1. A method for carbon sequestration and management through a wood storage project, comprising:
determining sources of wood used for storage for carbon sequestration with an optimization technique performed by one or more processing circuits;
calculating, with the one or more processing circuits, an optimized ratio between carbon sequestration efficiency and cost;
preparing storage facilities (Wood Vaults) with the optimized ratio between carbon sequestration efficiency and cost;
selecting suitable material for storage based on size and wholeness of wood with minimum exposed surface area;
sorting raw woody material including end-of-life wood products such as furniture, cross-laminated-timber, lamp poles, demolishing debris from the sources of wood into fine woody biomass (FWB) and coarse woody biomass (CWB); and
storing both the FWB and the CWB in the storage facilities.
establishing a monitoring, reporting, and verification (MRV) system to ensure the durable storage of wood and monitor any potential impact on the environment.

2. The method of claim 1, further comprising the construction of the storage facility based on the local condition in one of the 3 types: anoxic, dry, and cold. Wherein, anoxic storage facilities are built in low permeability soil with minimum saturated hydraulic conductivity of less than 10⁻⁸ m/s for at least a meter, topped with original topsoil to allow fully functioning biological activities in the topsoil; dry storage facilities are built to maintain bone-dry condition with relative air humidity of less than 10%; cold storage facilities are built by directly storing wood piles in clod places such as Antarctica with naturally freezing condition.

3. The method of claim 1, wherein the FWB and the CWB are separated by a threshold of 5-10 cm in diameter.

1. The method of claim 3, further comprising applying pyrolysis tools to make biochar out of the FWB and filling the biochar to spaces between CWB logs to optimize space use efficiency and reduce soil settlement while increasing total carbon use for sequestration.

2. The method of claim 1, further comprising mixing logs with mud in construction of structures comprising at least one of dikes or sea walls, and to enhance strengths of the structures while storing carbon. Logs should be completely wrapped inside the mud of at least 1 meter thickness in all outer directions.

3. The method of claim 1, further comprising embedding logs in soil or cement in a pattern. Logs should be completely wrapped inside the soil or cement of at least 0.5 meters thickness in all outer directions.

4. The method of claim 6, wherein the pattern comprises a crisscrossing pattern to meet a mechanical requirement of a construction structure.

5. The method of claim 1, further comprising directly pumping tree logs vertically into ground as foundations for constructions and raising the foundations of existing construction structures by pushing down the tree logs after building the existing construction structures.

6. The method of claim 8, further comprising parameterizing soil or dirt and selecting the soil or the dirt based on the parameterization to optimize the carbon sequestration in the storage facilities.

7. The method of claim 1, further comprising selecting coastal areas threatened by sea-level rise, constructing the storage facilities by burying woody biomass underground, refilling soil on top, and regrading surfaces of the selected coastal areas into higher structures than original flat low land, to create varying topography, enhancing biodiversity while combatting sea level rise.

8. The method of claim 1, further comprising installing sensors and instruments to monitor the storage facility for physical, chemical, and biological parameters for wood preservation, including but not limited to: concentrations of CO2, O2, CH4, temperature, humidity, pressure, pH, redox potential, dissolved O2.

9. The method of claim 1, further comprising of installing sensors to measure the fluxes of CO2 and CH4 to ensure there is no methane leakage into the atmosphere.

10. The method of claim 1, further comprising simulating, using the one or more processing circuits, gas concentrations, migration of gases and water and air in their horizontal and vertical movement, including transport via advection and diffusion in 3D numerical models.

11. The method of claim 13, wherein the 3D numerical models simulate distribution of biomass and gases including at least one of wood, O₂, CO₂, or CH₄, and bio-chem-physical processes that govern sources and sinks of the biomass and the gases, and diffusion/transport through soil layers.

12. The method of claim 14, further comprising simulating pH, and ORP redox potential (ORP).

13. The method of claim 15, further comprising calibrating and validating the 3D numerical models with experimental data.

14. The method of claim 16, wherein the 3D numerical models are configured to simulate gases and H₂O dynamics within the storage facilities and also processes along soil profiles to surface where greenhouse gases of CO₂ and CH₄ are emitted.

15. The method of claim 17, wherein the 3D numerical models comprise a model of transport, diffusion, with sources and sinks:
$$\frac{\partial C}{\partial t} = - v \cdot ∇ C - \frac{\partial {F}_{x} ( C )}{\partial x} - \frac{\partial {F}_{y} ( C )}{\partial y} - \frac{\partial {F}_{z} ( C )}{\partial z} + Sources - Sinks .$$

19. The method of claim 18, further comprising:
performing, with the one or more processing circuits, a carbon accounting including:
establishing a baseline including an assessment of lifetime of the sources of wood based on time scales including a half-life time, and a 5% decay time;
assessing a lifetime of buried wood based on storage methods and environmental conditions, wherein the lifetime of the buried wood is classified into stop-gap (<20 years), short-term (20-100 years), semi-permanent (100-1000 years), permanent (>1000 years), and ultra-permanent (>10000 years);
constructing a single-parameter model:
$$C = {C}_{0} exp ( - \frac{t}{τ} ) ,$$
wherein C is a carbon pool size with an initial value Co, t is time, and τ is an e-folding decay time scale, or,
constructing a multi-parameter model:
$$\frac{dC}{dt} = J ( t ) - {\int }_{0}^{τ} J ( t - τ ) Γ ( τ ) d τ ,$$
